(19) United States
(12) Patent Application Publication
(10) Pub. No.: US 2026/0280987 A1
(43) Pub. Date: Sep. 17, 2026

(54) ELEMENT SELECTION FOR NETWORK SLICE SUBNET PROVISIONING

(71) Applicant: Juniper Networks, Inc., Sunnyvale, CA (US)

(72) Inventors: Marc-Andre Bordeleau, Shawinigan (CA); Sukhdev S. Kapur, Saratoga, CA (US); Richard Roberts, Rennes (FR); Jeremy Alan Tidemann, Savoy, IL (US); Arda Akman, San Ramon, CA (US)

(21) Appl. No.: 19/076,797

(22) Filed: Mar. 11, 2025

(51) Int. Cl. H04L 41/0895; H04L 41/0806; H04L 41/147; H04L 41/5003

(52) U.S. Cl. CPC H04L 41/0895; H04L 41/0806; H04L 41/147; H04L 41/5003

(57) ABSTRACT

Techniques are disclosed for provisioning a network slice subnet in a mobile network. For example, a system determines requirements for a network slice subnet for deployment in a mobile network. The system identifies Radio Unit (RU) physical network functions (PNFs) of the mobile network that satisfy the requirements for the network slice subnet. From a plurality of cell sites hosting the identified RU PNFs, the system identifies cell sites that satisfy the requirements for the network slice subnet. The system identifies, based on the identified cell sites, data centers that satisfy the requirements for the network slice subnet. The system provisions the identified RU PNFs, the identified cell sites, and the identified data centers to provision the network slice subnet.

### TECHNICAL FIELD

The disclosure generally relates to mobile network management.

### BACKGROUND

Computer networks have become ubiquitous, and the number of network applications, network-connected devices, and types of network-connected devices are rapidly expanding. Such devices now include computers, smartphones, Internet-of-Things (IoT) devices, vehicles, medical devices factory equipment, etc. 5G mobile network architectures enhanced the ability to provide communication services using cloud-based network function virtualization (NFV). Specialized networks can be created using the Radio Access Network (RAN) of a mobile network operator combined with functions of a 5G core. For example, networks can be created for a specific service level agreement (SLA), special use cases, or other specific requirements. Examples of such networks include private mobile networks, industrial networks, a dedicated network for connected vehicles, etc.

### SUMMARY

In general, the disclosure describes techniques for provisioning a network slice subnet in a mobile network. In some examples, the mobile network is a 4th generation (4G), 5th generation (5G), 6th generation (6G), or next generation (xG) mobile network. In an example of the techniques of the disclosure, a computing system, such as a network provisioning system, a Service and Management Orchestration platform (SMO), and/or a RAN intelligent controller (RIC), determines one or more requirements for a network slice subnet for deployment in a mobile network. The computing system identifies one or more Radio Unit (RU) physical network functions (PNFs) of a plurality of RU PNFs of the mobile network that satisfy the one or more requirements for the network slice subnet. From a plurality of cell sites of the mobile network hosting the identified one or more RU PNFs, the computing system may identify one or more cell sites of the plurality of cell sites that satisfy the one or more requirements for the network slice subnet. Based on the identified one or more cell sites, the computing system may identify one or more edge cloud data centers of a plurality of edge cloud data centers of the mobile network that satisfy the one or more requirements for the network slice subnet. Based on the identified edge cloud data centers, the computing system may identify one or more regional cloud data centers of a plurality of regional cloud data centers of the mobile network that satisfy the one or more requirements for the network slice subnet.

The computing system provisions the identified one or more RU PNFs and one or more of the identified one or more cell sites, the identified one or more edge cloud data centers, or the identified one or more regional cloud data centers to implement the network slice subnet. In some examples, the network slice subnet is a RAN slice subnet. In other examples, the network slice subnet may be another type of slice subnet, such as a transport network slice subnet or a core network slice subnet, or an entire network slice.

The techniques of the disclosure provide specific improvements to the computer-related field of mobile telecommunications and networking that have one or more practical applications. For example, during provisioning of a network slice or network slice subnet, a conventional system may be able to select various elements of a mobile network that individually conform to performance requirements or SLA requirements, but may be unable to ensure that the elements collectively, when provisioned and implementing the network slice or network slice subnet, adhere to the performance requirements. The techniques of the disclosure may enable a network provisioning system to apply a “bottom-to-top” approach to network slice subnet provisioning so as to better evaluate the feasibility of provisioning a network slice or network slice subnet that adheres to SLA requirements across the entire mobile network infrastructure. Moreover, the techniques of the disclosure may enable a network provisioning system to use the resources and elements of a mobile network infrastructure more efficiently, thereby reducing network congestion and increasing the number of network slices or network slice subnets that may be provisioned within a given mobile network.

In one example, this disclosure describes a computing system comprising processing circuitry having access to a memory, the processing circuitry configured to: determine one or more requirements for a network slice subnet to be provisioned in a mobile network; identify one or more Radio Unit (RU) physical network functions (PNFs) of a plurality of RU PNFs of the mobile network that satisfy the one or more requirements for the network slice subnet; from a plurality of cell sites hosting the identified one or more RU PNFs, identify one or more cell sites of the plurality of cell sites that satisfy the one or more requirements for the network slice subnet; identify, based on the identified one or more cell sites, one or more data centers of a plurality of data centers that satisfy the one or more requirements for the network slice subnet; and provision the identified one or more RU PNFs, the identified one or more cell sites, and the identified one or more data centers to provision the network slice subnet.

In another example, this disclosure describes a method comprising: determining, by processing circuitry of a computing system, one or more requirements for a network slice subnet to be provisioned in a mobile network; identifying, by the processing circuitry, one or more Radio Unit (RU) physical network functions (PNFs) of a plurality of RU PNFs of the mobile network that satisfy the one or more requirements for the network slice subnet; from a plurality of cell sites hosting the identified one or more RU PNFs, identifying, by the processing circuitry, one or more cell sites of the plurality of cell sites that satisfy the one or more requirements for the network slice subnet; identifying, by the processing circuitry and based on the identified one or more cell sites, one or more data centers of a plurality of data centers that satisfy the one or more requirements for the network slice subnet; and provisioning, by the processing circuitry, the identified one or more RU PNFs, the identified one or more cell sites, and the identified one or more data centers to provision the network slice subnet.

In another example, this disclosure describes non-transitory, computer-readable media comprising instructions that, when executed, are configured to cause processing circuitry to: determine one or more requirements for a network slice subnet to be provisioned in a mobile network; identify one or more Radio Unit (RU) physical network functions (PNFs) of a plurality of RU PNFs of the mobile network that satisfy the one or more requirements for the network slice subnet; from a plurality of cell sites hosting the identified one or more RU PNFs, identify one or more cell sites of the plurality of cell sites that satisfy the one or more requirements for the network slice subnet; identify, based on the identified one or more cell sites, one or more data centers of a plurality of data centers that satisfy the one or more requirements for the network slice subnet; and provision the identified one or more RU PNFs, the identified one or more cell sites, and the identified one or more data centers to provision the network slice subnet.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram illustrating an example network system configured to provision a network slice subnet within a mobile network, in accordance with one or more techniques of the disclosure.

FIG. 1B is a block diagram illustrating further example details of the Non-RT RIC of the Service Management and Orchestration platform of FIG. 1A.

FIG. 1C is a block diagram illustrating further example details of the Near-RT RIC of FIG. 1A.

FIG. 2 is a block diagram illustrating an example computing system in detail, in accordance with the techniques of this disclosure.

FIG. 3 is a flowchart illustrating an example operation in accordance with the techniques of this disclosure.

FIGS. 4A–4H are block diagrams illustrating an example operation for provisioning a network slice subnet within a mobile network, in accordance with one or more techniques of the disclosure.

Like reference characters refer to like elements throughout the figures and description.

### DETAILED DESCRIPTION

Network Slicing is a key innovative feature of 5G networks that requires orchestration of end-to-end virtual networks across RAN, Transport Network (TN) and Core Network (CN). The network slices are defined with strict SLA and must be optimized with respect to multi-dimensional requirements. These multi-dimensional requirements may include, e.g., throughput, latency, isolation, security, maximum number of UEs, etc. Within each domain (RAN, TN, CN), the orchestration and SLA optimization of a network slice subnet (also referred to herein as a “sub-slice,” e.g., a portion of an end-to-end network slice that belongs to a particular domain) has domain-specific challenges, and the RAN is arguably the most complex domain to slice.

Conventional techniques related to network function placement for slicing use-cases are not specific to the RAN domain. For instance, such conventional techniques consider generic inter-cloud placement with respect to two generic SLA attributes: cloud load and geographic area. 3GPP (the main standard body that defines 5G Network Slicing specifications) started defining the concepts, use cases and requirements for network slicing management in 3GPP TS 28.530 (2017). In addition, the O-RAN specification for Slicing Architecture, O-RAN.WG1.TS.Slicing-Architecture-R004-v13.01, provides procedures and requirements for RAN Slicing orchestration. However, these standards and specifications do not provide any solution about how to realize optimized Network Function placement for RAN Slicing Orchestration. For example, the O-RAN specification provides high-level objectives, such as “Derive O-Cloud requirements for O-RAN NF,” without providing detail on what should be implemented or how the implementation should operate, and does not describe how one may optimize the placement by combining various types of requirements for Cloud, Transport, Radio Link, etc. For example, the O-RAN specification does not explain how one may resolve the issue where a cloud satisfies performance requirements for a network slice, but a transport link to the cloud does not satisfy the performance requirements.

The techniques of the disclosure provide an innovative solution for optimizing the orchestration of RAN slices, in particular for the dynamic placement of Network Functions (NFs) across highly distributed RAN networks, which comprise a large number of sites, network links, and heterogenous technologies. The techniques of the disclosure may provide advantages for the RAN Slicing Orchestration use case, and address the diversity and complexity of NF placement challenges inherent to the RAN domain.

The techniques of the disclosure may provide numerous advantages over conventional techniques for network function placement for slicing use-cases. For example, a network provisioning system as described herein may support slicing for multi-technology RAN networks, such as 5G RANS, that comprise multiple heterogenous technologies, each with their own characteristics, constraints, and requirements. The main technologies of RAN networks are Radio links, fixed physical network functions (PNFs, such as radio units (RUs)), intra- and inter-domain transport links (front-haul, mid-haul, back-haul), highly distributed infrastructure (cell sites, data centers, clouds), virtualized/containerized network functions (VNF/CNF, e.g. DU, CU) with strict placement requirements, etc. A network provisioning system as described herein may support such heterogenous RANs while ensuring adherence to SLA requirements across the network slice and/or RAN slice subnet. The network provisioning system as described herein provides multi-dimensional NF placement optimization for RAN slices that considers the multiple technologies inherent to the RAN, the highly distributed nature of RAN, the complexity of the SLA requirements, and the varying capabilities and constraints for enforcement.

For example, a network provisioning system as described herein may support complex RAN topologies with multi-path networks. If a RAN is a single path network from user equipment (UE) to RAN RU, DU and CU, then it is easy to perform optimized NF placement for a given slice SLA. However, due to highly distributed nature of a RAN that may include tens of thousands of cell sites, edge and regional data centers, each RAN segment is composed of a very large number of network paths. A network provisioning system as described herein may support the provisioning of a network slice or network slice subnet within such complex RAN topologies.

Furthermore, a network provisioning system as described herein may support adherence to multi-dimensional SLA requirements. A slice SLA may be defined with multiple types of parameters, with possible conflicting requirements, for which the slice needs to be monitored and optimized. These parameters may include, e.g., throughput, latency, slice priority, etc. A network provisioning system as described herein may implement a RAN Slice optimization algorithm that measures, evaluates, and aggregates different metrics in term of actual usage (performance metrics) and available capacity (inventory, configuration), so as to support multi-dimensional SLA requirements.

Furthermore, a network provisioning system as described herein may enable the provisioning of a network slice or network slice subnet according to diverse and complex performance metrics for radio/spectrum, transport network and cloud, and data center. Each of these metrics may have their own granularity. For example, in a RAN, metrics are often cell-based, while in the transport network, metrics may be link-based, and within the cloud, metrics may be site or host-based. A network provisioning system as described herein may support the provisioning of a network slice or network slice subnet that satisfies the diverse and complex performance metrics of many types that may exist within a mobile network, as well as supporting different capabilities for enforcing the slice requirements depending on the underlying technology (RAN, Transport or Cloud).

In addition, a network provisioning system as described herein may reduce the complexity of optimizing a slice for its own SLA requirements (intra-slice optimization), without impacting other competing slices and allowing for oversubscription of the underlying infrastructure (inter-slice optimization). In other words, within a single slice, a network provisioning system as described herein may make globally optimized placement decisions that consider the multi-dimensional problem in which an optimal decision for a given SLA parameter may impact or conflict with fulfillment of another parameter. Such a network provisioning system as described herein may reduce the occurrence of a solution that addresses RAN requirements, but does not satisfy requirements for the transport or cloud portion of a network slice.

Accordingly, a network provisioning system as described herein may provide optimized RAN NF placement. Furthermore, a network provisioning system as described herein may provide more accurate evaluation of the feasibility of RAN slices and reduce the occurrence of network overprovisioning. Thus, the techniques described herein may provide direct return on investment to operators by increasing the number of slices that can be realized on a given infrastructure, by which one may increase revenues from Network Security as a Service (NSaaS) and reduce infrastructure capital expenditure.

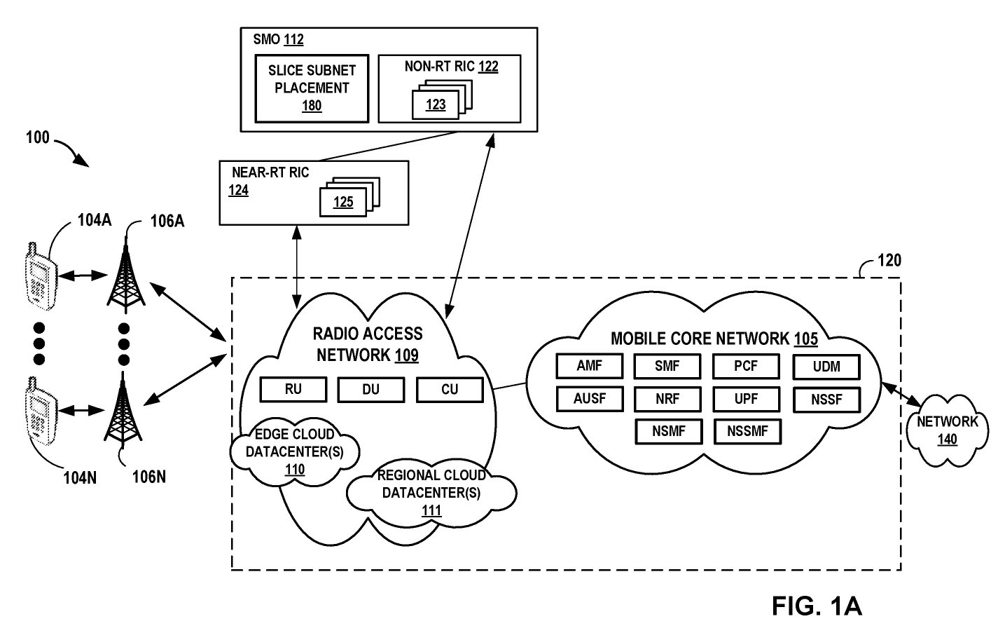

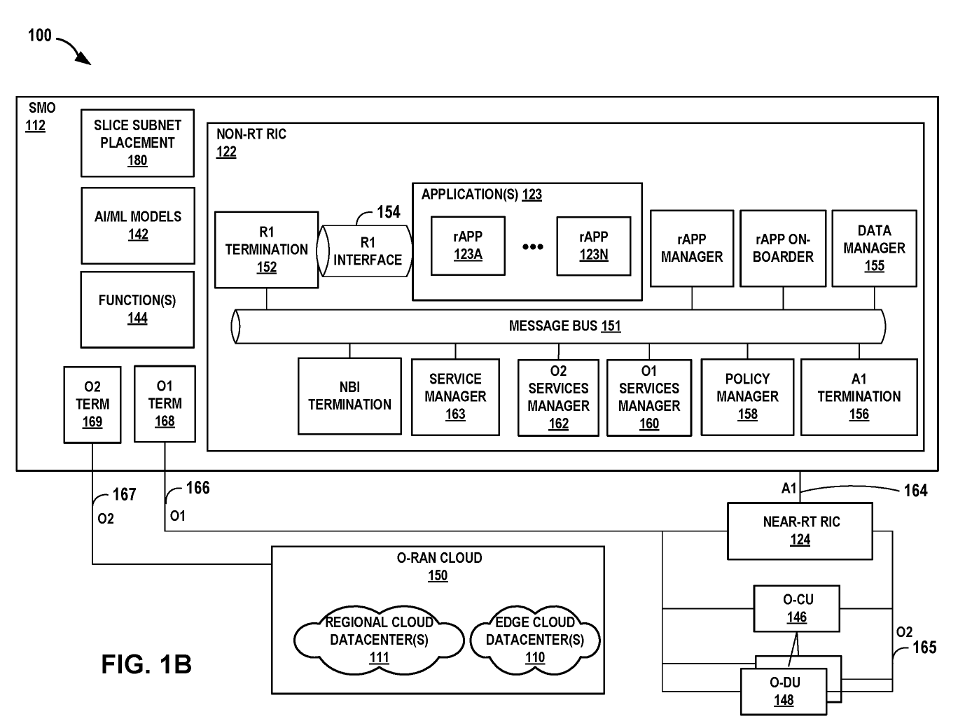

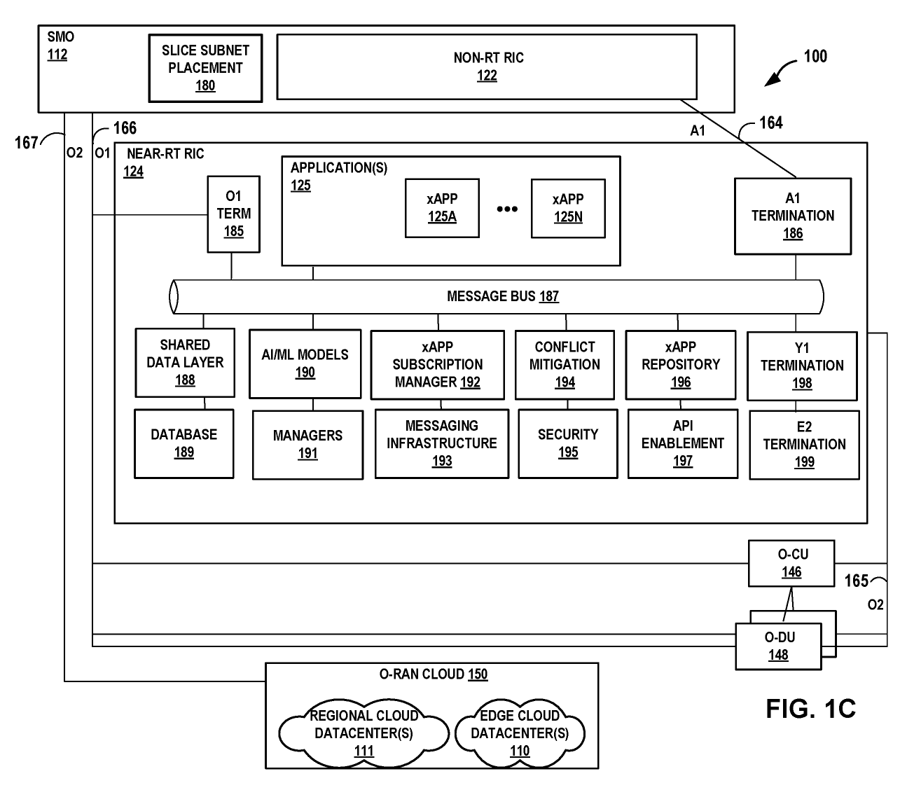

FIG. 1A is a block diagram illustrating an example network system configured to provision a network slice subnet within a mobile network, in accordance with one or more techniques of the disclosure. In the example illustrated in FIG. 1A, network system 100 includes Service and Management Orchestration platform (SMO) 112, non-RT RIC 122, near-RT RIC 124, and mobile network 120. Mobile network 120 includes one or more respective radio access networks (RANs), e.g., RANs 109, and one or more corresponding mobile core networks (or simply “cores”) 105 (collectively, “mobile core networks 105”) that provide user equipment 104A–104N (collectively, “UEs 104”) with access to one or more applications or services provided by data network 140. In some examples, mobile network 120 comprises 4G, 5G, 6G, or xG mobile networks.

UEs 104 may represent smartphones, desktop computers, laptop computers, tablets, smart watches, and/or “Internet-of-Things” (IOT) devices, such as cameras, sensors, televisions, appliances, or the like. As shown in FIG. 1A, mobile network 120 includes a respective RAN 109 that provides network access, data transport, and other services to UEs 104. In some examples, RAN 109 may be an O-RAN, a 5G mobile network RAN, a 4G LTE mobile network RAN, another type of RAN, or a combination of the above. For example, in a 5G-radio access network, RAN 109 comprises a plurality of cell sites (or simply “cells”) that each include radio equipment, such as respective base stations 106A–106N (collectively, “base stations 106”), also known as gNodeBs, to exchange packetized data within a data network to ultimately access one or more applications or services provided by data network 140. Each of base stations 106 is divided into three functional components: RU, distributed unit (DU), and central unit (CU), which can be deployed in various configurations. RU manages the radio frequency layer and has antenna arrays of various sizes and shapes. DU performs lower layer protocol processing. CU performs the upper layer protocol processing. Depending on operator and service requirements, base stations 106 can be deployed monolithically, e.g., RU, DU, and CU reside within a cell site, or these functionalities can be distributed across cell sites while the CU resides in an edge cloud site controlling a plurality of distributed DUs. O-RAN is, for example, an approach to networking in which disaggregated functions can be used to deploy mobile fronthaul and midhaul networks. The disaggregated functions can be cloud-based functions.

In some examples, RAN 109 further includes edge cloud datacenters 110 and regional cloud datacenters 111. Edge cloud datacenters 110 provide a number of virtualized network services and/or network functions for mobile network 120. For example, servers of edge cloud data center 110 may host DU and CU virtualized network functions for base stations 106. Edge cloud data centers 110 may also provide network transport functions within a particular geographic region of RAN 109. Regional cloud datacenters 111 also provide a number of virtualized network services and/or network functions for mobile network 120, as well as providing network transport functions across large geographic regions, so as to provide interconnectivity between edge cloud data centers 110 of different geographic regions. The network functions and network services provided by edge cloud datacenters 110 and regional cloud datacenters 111 may be decentralized or distributed across a number of different servers or compute nodes.

RAN 109 of mobile network 120 connects to core 105 to exchange packets with a respective data network 140. Core 105 may be a 5G core network, and data network 140 may represent, for example, one or more service provider networks and services, the Internet, third party services, one or more IP-VPNs, an IP-multimedia subsystem, a combination thereof, or other network or combination of networks. In some examples, resources associated with the service provided by a mobile network operator to the tenant may be provided by, or managed by, functions of core 105 and/or components of RAN 109. In some examples, core 105 implements various discrete control plane and user plane functions for network system 100. Examples of 5G control plane functions that may be provided by core 105 include Access Mobility Management Function (AMF) that provides access mobility management services, Session Management Function (SMF) that provides session management services, Policy Control Function (PCF) that provides policy control services, User Data Management (UDM) that provides management of network user data, Network Repository Function (NRF) that provides a repository that can be used to register and discover services in a network operator’s network, Authentication Server Function (AUSF) that provides authentication services, Network Slice Selection Function (NSSF), NSMF that may be used to select an instance of an available network slice for use by any of UE devices 104, and Network Slice Subnet Management Function (NSSMF) that provides coordination, management, and orchestration of network slice subnet instances (NSSI). Core 105 may also include User Plane Functions (UPF) that provides packet routing, forwarding and other network data processing functions (e.g., Quality of Service, packet inspection, traffic optimization etc.). Further details on services and functions provided by the 5G core, can be found in 3^{rd} Generation Partnership Project 2021, Technical Specification Group Services and System Aspects; System architecture for the 5G System (5GS); Stage 2 (Release 17), TS 23.501 V17.0.0 (2021-03), which is superseded by 2021, Technical Specification Group Services and System Aspects; System architecture for the 5G System (5GS); Stage 2 (Release 18), TS 23.501 V18.2.2 (2023-07), the entire contents of each of which are hereby incorporated by reference. Further details on the O-RAN architecture can be found in O-RAN Alliance, “O-RAN Architecture Description,” version 7.00, October 2022, the entire contents of which is hereby incorporated by reference.

In some examples, network system 100 is an example of a 4th generation (4G) mobile network, a 5th generation (5G) mobile network, or a 6th generation (6G) mobile network. A network system, such as network system 100, may include a Service Management and Orchestration (SMO) framework offering various framework functions along with a non-RT RIC, configured in accordance with O-RAN standards (“O-RAN architecture”), to manage and/or monitor aspects of a RAN and/or 5G core. The O-RAN architecture may include a non-RT RIC and a near-RT that each executes different functions and services for RAN functions. A non-RT RIC is an orchestration and automation function configured to provide radio resource management, higher layer procedure optimization, policy optimization, and provide guidance, parameters, policies and artificial intelligence (AI) and machine learning (ML) models to support the operation of near-RT RIC functions in the RAN. The non-RT RIC may onboard one or more applications (e.g., rApps) that provide non-real time (e.g., greater than one second) control of RAN elements and their resources, and the near-RT RIC may onboard one or more applications (e.g., xApps) that provide near-real time control of RAN elements and their resources.

The O-RAN architecture includes several interfaces, such as A1, O1, and O2 interfaces, that are each used to provide the functions and services by which the SMO and RIC can configure or direct other components of the RAN. For example, the functions and services of a non-RT RIC may include policy management services and/or enrichment information services for a near-RT RIC that are provided over an A1 interface (collectively referred to herein as “A1 services” because they provided over the A1 interface); OAM services, such as performance management services and configuration management services, for O-RAN management elements that are provided over an O1 interface (referred to herein as “O1 services” because they are provided over the O1 interface); infrastructure management services and deployment management services for resources of an O-RAN cloud that are provided over an O2 interface (referred to herein as “O2 services” because they are provided over the O2 interface), and/or other services, such as SME services (e.g., registration of a service, update of a service registration), DME services, and/or AI/ML services.

As depicted in the example of FIG. 1A, aspects of RAN 109 and/or core 105 may be managed and/or monitored by SMO 112, non-RT RIC 122, and near-RT RIC 124. In some examples, SMO 112, non-RT RIC 122, and near-RT RIC 124 may be operated by the mobile network operator providing 5G services to a tenant. SMO 112 can orchestrate and control management and automation aspects of RAN 109 (e.g., network slicing, management, and orchestration of O-Cloud, etc.). Further, SMO 112 may control aspects of non-RT RIC 122 and near-RT RIC 124. Non-RT RIC 122 can provide non-real-time (e.g., greater than one second) control and optimization of RAN elements and resources such as RUs, DUs, and CUs, workflow management, and policy-based control of applications and features of near-RT RIC 124. Near-RT RIC 124 can provide near-real-time (e.g., milliseconds) control and optimization of RAN elements and resources via fine-grained data collection and actions. As further described in FIG. 1B, non-RT RIC 122 and near-RT RIC 124 may deploy as a highly scalable, microservices based containerized architecture. In some examples, near-RT RIC 124 may be located within an edge or regional cloud.

Non-RT RIC 122 may onboard one or more applications, e.g., applications 123 (e.g., rApps of FIG. 1B) that manage non-real time events within non-RT RIC 122, such as applications that do not require response times of less than one second. Applications 123 may leverage the functionality exposed via the non-RT RIC framework of non-RT RIC 122. Applications 123 may be used to control and manage RAN elements and resources, such as near-RT RIC 124, RAN nodes, and/or resources in the O-RAN cloud. Applications 123 may also utilize network data, performance metrics, and subscriber data to provide recommendations for network optimization and operational guidance (e.g., policies) to one or more applications of near-RT RIC 124. Although illustrated as within non-RT RIC 122, any one or more of applications 123 may be executed by a third party, separate from non-RT RIC 122.

As described further below, non-RT RIC 122 may provide services using management interfaces such as the A1, O1, O2, and OAM interfaces. An A1 interface connects the non-RT RIC 122 and near-RT RIC 124. Non-RT RIC 122 may perform services via the A1 interface, such as policy management services (e.g., creation and update of a policy), ML model management services, and/or enrichment information services. Services performed via the A1 interface are referred to herein as “A1 services.” An O1 interface may include an interface that connects SMO 112 with O-RAN managed elements, such as near-RT RIC 124 and/or RAN nodes (e.g., O-RAN centralized unit (O-CU), O-RAN distributed unit (O-DU)). Non-RT RIC 122 may perform services via the O1 interface, such as configuration management services and performance management services of O-RAN managed elements (e.g., OAM services), fault supervision, file management, heartbeat, trace, physical network function (PNF) discovery, software management, etc.). Services performed via the O1 interface are referred to herein as “O1 services.” An O2 interface may include an interface that connects SMO 112 to resources of the ORAN O-Cloud. The O-Cloud may comprise of one or more physical infrastructure nodes that host O-RAN functions (e.g., virtual network functions), the supporting software components, and the appropriate management and orchestration functions. Non-RT RIC 122 may perform services via the O2 interface, such as services that provide infrastructure management and/or network function deployment of the resources in the O-Cloud (e.g., discovery and administration of O-Cloud resources; Scale-In, Scale-Out of cloud/deployments; Fault, Configuration, Accounting, Performance, and Security (FCAPS) of cloud/deployments, software management of cloud platform/deployments; create/delete deployment and associated allocated O-Cloud resources). Services performed via the O2 interface are referred to herein as “O2 services.” Non-RT RIC 122 may perform services via the IAN interface, such as configuration management services and performance management services of non-O-RAN managed elements (e.g., OAM services), fault supervision, file management, heartbeat, trace, physical network function (PNF) discovery, software management, etc.). Services performed via the OAM interface are referred to herein as “OAM services.” Non-RT RIC 122 may also perform other functions and services, such as SME services (e.g., registration of a service, update of a service registration), DME services, AI/ML services, or the like.

In some examples, non-RT RIC 122 and near-RT RIC 124 implement a standardized or standards-specified data model, such as an O-RAN data model, to provide OAM operations for RAN 109. However, RAN 109 may include network devices provided by various vendors, each of which may use a different vendor-specific data model for implementing OAM telemetry and control that may not adhere to 3GPP/O-RAN standards. Supporting the various vendor-specific data models conventionally may require complex configuration in the OAM chain, thereby increasing the cost and maintenance for network operations.

In accordance with the techniques of the disclosure, SMO 112 includes network slice subnet placement 180, which selects resources that may be used to provision a network slice subnet within mobile network 120. In some examples, network slice subnet placement 180 is a RAN NSSMF for RAN 109. While network slice subnet placement 180 is depicted as being part of SMO 112, in other examples, network slice subnet placement 180 may be part of non-RT RIC 112, near-RT RIC 112, or a network function implemented by or within, e.g., RAN 109 or mobile core network 105. In some examples, the network slice subnet is a RAN slice subnet for provisioning within RAN 109. In other examples, the network slice subnet may be another type of slice subnet, such as a transport network slice subnet or a core network slice subnet, or an entire network slice.

As depicted in the example of FIG. 1A, network slice subnet placement 180 of SMO 180 determines one or more requirements for a RAN slice subnet for deployment in mobile network 120. In some examples, the one or more requirements are performance requirements for, e.g., RU PNFs, cell sites, transport links, edge cloud data centers, or regional cloud data centers.

Network slice subnet placement 180 identifies one or more RU PNFs of base stations 106 that satisfy the one or more requirements for the network slice subnet. From a plurality of cell sites of mobile network 120 hosting the identified one or more RU PNFs of base stations 106, network slice subnet placement 180 identifies one or more cell sites (not depicted in FIG. 1A) of the plurality of cell sites that satisfy the one or more requirements for the network slice subnet. In some examples, each cell site of the plurality of cell sites is associated with a tracking area of a plurality of tracking areas. The identified one or more cell sites may be associated with one or more tracking areas within which the network slice subnet is to be provisioned.

Based on the identified one or more cell sites, network slice subnet placement 180 identifies one or more edge cloud data centers 110 of a plurality of edge cloud data centers 110 of mobile network 120 that satisfy the one or more requirements for the network slice subnet. In some examples, each edge cloud data center of the plurality of edge cloud data centers is associated with a geographic location of a plurality of geographic locations. The identified one or more edge cloud data centers may be associated with one or more geographic locations within which the network slice subnet is to be provisioned. In some examples, each edge cloud data center of the plurality of edge cloud data centers hosts DUs and CUs for the RU PNFs.

Based on the identified edge cloud data centers, network slice subnet placement 180 identifies one or more regional cloud data centers 111 of a plurality of regional cloud data centers 111 of mobile network 120 that satisfy the one or more requirements for the network slice subnet. In some examples, network slice subnet placement 180 identifies one or more first links (e.g., edge transport links) of a plurality of first links that interconnect the identified one or more cell sites and the identified one or more edge cloud data centers that satisfy the one or more requirements for the network slice subnet. Network slice subnet placement 180 may further identify one or more second links (e.g., regional transport links) of a plurality of second links that interconnect the identified one or more edge cloud data centers and the identified one or more regional cloud data centers that satisfy the one or more requirements for the network slice subnet.

Network slice subnet placement 180 provisions the identified one or more RU PNFs, the identified one or more cell sites, the identified one or more edge cloud data centers, the identified one or more first links, the identified one or more regional cloud data centers, and the identified one or more second links, to provision the network slice subnet. Accordingly, using the techniques disclosed herein, when selecting elements upon which to provision a network slice subnet, network slice subnet placement 180 considers only those elements for adherence to performance requirements for the network slice subnet that are supported by sub-elements that adhere to the performance requirements.

FIG. 1B is a block diagram illustrating further example details of the non-RT RIC 122 of FIG. 1A. In the example illustrated in FIG. 1B, SMO 112 may include non-RT RIC 122, one or more AI/ML models 142, one or more functions 144 (e.g., NSSMF, NFMF, and other functions), and open interfaces, such as O1 termination interface 168 and O2 termination interface 169. SMO 112 may manage non-RT RIC 122, near-RT RIC 124, O-RAN managed elements (e.g., centralized unit (O-CU) 146, O-RAN decentralized unit (O-DU) 148 of one or more base stations), and resources in O-RAN cloud 150.

Non-RT RIC 122 may provide non-real-time (e.g., greater than one second) control and optimization of RAN elements and resources such as RUs, DUs, and CUs, workflow management, and policy-based control of applications and features of near-RT RIC 124. Non-RT RIC 122 may be deployed as a highly scalable, microservices based containerized architecture. In this example, non-RT RIC 122 may onboard, deploy, and/or terminate one or more applications, e.g., rApp 123A through rApp 123N (collectively “applications 123”). Applications 123 may represent applications that leverage the functionality exposed via the framework of non-RT RIC 122. Applications 123 may provide non-RT RIC 122 with non-real time (e.g., greater than one second) control of RAN elements and their resources. Applications 123 may provide services for radio resource management, higher layer procedure optimization, policy optimization, and providing guidance, parameters, policies, and AI/ML models to support the operation of RAN functions.

For example, applications 123 may provide A1 services that provide and facilitate RAN operations and optimization of near-RT RIC 124, such as providing operational guidance (e.g., policies), enrichment information (e.g., forecasts), and AI/ML services. A1 services may include policy management services such as creating, updating, and/or deleting of A1 policies; receiving policy feedback; querying policy types, identifiers, and status; defining which policy types are supported by near-RT RIC 124; and registering applications (xApps) of near-RT RIC 124 to specific policy types. A1 services may include enrichment information services, such as providing data for model training of AI/ML models, such as forecasts and/or data analytics.

Applications 123 may provide O1 services that provide configuration management or performance management of O-RAN managed entities, such as near-RT RIC 124 and/or RAN nodes, e.g., O-CU 146, O-DU 148 (also referred to herein as “E2 nodes”). O1 services may provide configuration management services to create, update, and/or delete configurations to O-RAN managed entities. For example, configuration management services may include provisioning operations (e.g., for NSS and NF provisioning) to create a managed object instance (MOI), obtain MOI attributes, modify MOI attributes, and/or delete the MOI. O1 services may also provide performance management services that monitor the status of elements or components in the O-RAN managed entities. For example, non-RT RIC 122 may create, modify, or delete performance management jobs to receive performance metrics, or send heartbeat messages to monitor the status and/or availability of services of RAN nodes or to send trace messages to monitor link failures. O1 services may also provide file management, such as to push files to the RAN nodes (e.g., software updates, beamforming configuration files, ML models, security certificates, etc.).

Applications 123 may provide O2 services that provide infrastructure management and/or network function deployment of resources in O-RAN cloud 150 (also referred to herein as “O-Cloud 150”). O2 services may provide discovery and administration of O-Cloud resources; Scale-In, Scale-Out of cloud/deployments (e.g., deploying resources with more or less processors); FCAPS of cloud/deployments, software management of cloud platform/deployments; create/delete deployment and associated allocated O-Cloud resources.

Applications 123 may provide SME services, DME services, and/or other services. SME services may provide services that enable services provided over an internal interface (R1 interface 154) of non-RT RIC 122 and their exposure and extensibility through services including bootstrap, service registration/deregistration or updates to service registration, service discovery or notification, heartbeat, authentication, authorization, etc. DME services may include services that manage data and their exposure between applications 123. For example, applications 123 may have different functions, such as application 123A configured to collect and analyze data, application 123B configured to generate an ML model based on the results of the analysis, and application 123N configured to make a prediction or inference using the ML model and/or to generate controls for RAN nodes based on the prediction or inference. DME services may manage the data shared between applications 123, such as the collection of data, the processing of the data, and/or the advertisement of the data.

Non-RT RIC 122 may include one or more managers to process the A1, O1, O2, SME, DME services, and other services. For example, non-RT RIC 122 may include a policy manager 158, O1 services manager 160, O2 services manager 162, service manager 163, and data manager 155. Non-RT RIC 122 may include other managers, such as an application manager and an application on-boarder, that are configured to manage the installation and deployment of applications 123.

Policy manager 158 is configured to control the deployment of policies (e.g., A1 services). For example, in response to receiving requests for A1 services from applications 123 via R1 interface 154, R1 interface 154 sends the requests to policy manager 158 via message bus 151. Policy manager 158 may process the A1 services and may send the A1 services to A1 termination 156 via message bus 151, which provides the A1 services to near-RT RIC 124 via A1 interface 164. In some examples, the A1 interface may implement an A1AP application protocol based on the O-RAN specifications.

O1 services manager 160 is configured to control the deployment of O1 services for monitoring the performance of near-RT RIC 124 and/or RAN nodes (e.g., O-CU 146, O-DU 148). For example, in response to receiving requests for O1 services for monitoring the performance of near-RT RIC 124 from applications 123 via R1 interface 154, R1 interface 154 sends the requests to O1 services manager 160 via message bus 151. O1 services manager 160 may process the O1 services and may send the O1 services to O1 termination 168, which provides the O1 services to near-RT RIC 124 via O1 interface 166. In some examples, the O1 interface may implement REST/HTTPS APIs and/or NETCONF.

O1 services manager 160 is additionally, or alternatively, configured to control the deployment of O1 services for the configuration of near-RT RIC 124 and/or RAN nodes. For example, in response to receiving requests for O1 services for the configuration of near-RT RIC 124 from applications 123 via R1 interface 154, R1 interface 154 sends the requests to O1 services manager 160. O1 services manager 160 may process the O1 services and may send the O1 services to O1 termination 168, which provides the O1 services to near-RT RIC 124 via O1 interface 166.

O2 services manager 162 may be configured to control the deployment of O2 services for monitoring the performance of resources of O-Cloud 150. For example, in response to receiving requests for O2 services for monitoring the performance of resources within O-Cloud 150 via R1 interface 154, R1 interface 154 sends the request to O2 services manager 162. O2 services manager 162 may process the O2 services and may send the O2 services to O2 termination 169, which provides the O2 services to resources of O-Cloud 150 via O2 interface 167.

O2 services manager 162 may additionally, or alternatively, be configured to control the deployment of O2 services for the configuration of resources of O-Cloud 150. For example, in response to receiving requests for O2 services for configuring resources within O-Cloud 150 from applications 123 via R1 interface 154, R1 interface 154 sends the requests to O2 services manager 162. O2 services manager 162 may process the O2 services and may send the O2 services to O2 termination 169, which provides the O2 services to resources of O-Cloud 150 via O2 interface 167.

In some examples, R1 interface 154 also exposes applications 123 to SME services, DME services, and/or other services. For example, in response to receiving requests for SME services from applications 123 via R1 interface 154, R1 interface 154 sends the requests to service manager 163. Service manager 163 may process the SME services (e.g., register/update a service) and may send the SME services to R1 termination 152, which provides the SME services to applications 123 via R1 interface 154 (e.g., sending response to application regarding service registration, update, or discovery). Similarly, in response to receiving requests for DME services from applications 123 via R1 interface 154, R1 interface 154 sends the requests to data manager 155. Data manager 155 may process the DME services and may send the DME services to R1 termination 152, which provides the DME services to applications 123 via R1 interface 154 (e.g., sending data from application configured as a data producer to application configured as a data consumer).

R1 interface 154 may also expose applications 123 to slice subnet management services, such as RAN NSSMF interfaces to retrieve slice SLAs and slice topologies, and/or slice management, SLA, and slice performance management notifications to applications 123.

In some examples, SMO 112 and non-RT RIC 122 implement a standardized or standards-specified data model, such as an O-RAN data model, to provide OAM operations for RAN 109. With respect to the O-RAN OAM model, a managed element (ME) is a device, service, or application that supports communication over management interface(s) to a management entity (such as SME 112 or Non-RT RIC 122) for purposes of control and monitoring. A managed function (MF) instance is managed using a management interface exposed by its containing ME instance. The O-RAN OAM architecture adds an interface for OAM operations, labeled “O1.” O1 is the interface between the O-RAN ME and the management entity.

O-RAN specifies a number of different data models for OAM operations. SMO 112 and non-RT RIC 122 may support the use of a single O-RAN OAM model or multiple O-RAN OAM models. For example, in an O-RAN flat management architecture model, all MFs comprising the O-RAN architecture are also MEs and expose an O1 interface to SMO 112. In an O-RAN hierarchical management architecture model, a higher level ME is used to manage a subnetwork of Mes, such as where a DU manages an RU using a front-haul M-plane interface. In an O-RAN hybrid management architecture model, the RU is managed partially by the DU and partially by SMO 112. The O1 interface may be terminated directly on SMO 112 in a flat model, or in a hierarchical model, the O1 interface may be terminated on a ME which manages other O-RAN MFs.

Additional information regarding the O-RAN data model for OAM data in set forth in O-RAN Operations and Maintenance Interface 4.0, O-RAN.WG1.O1-Interface.0-v04.00, O-RAN Alliance, Feb. 2021, available at https://specifications.o-ran.org/specifications, and O-RAN Operations and Maintenance Architecture 4.0, O-RAN.WG1.OAM-Architecture-v04.00, O-RAN Alliance, Feb. 2021, available at https://specifications.o-ran.org/specifications, the entire content of each of which is hereby incorporated by reference.

In accordance with the techniques of the disclosure, SMO 112 includes network slice subnet placement 180, which selects resources that may be used to provision a network slice subnet within mobile network 120. In some examples, network slice subnet placement 180 is a RAN NSSMF for RAN 109. While network slice subnet placement 180 is depicted as being part of SMO 112, in other examples, network slice subnet placement 180 may be part of non-RT RIC 112, near-RT RIC 112, or a network function implemented by or within, e.g., RAN 109 or mobile core network 105. In some examples, the network slice subnet is a RAN slice subnet for provisioning within RAN 109. In other examples, the network slice subnet may be another type of slice subnet, such as a transport network slice subnet or a core network slice subnet, or an entire network slice.

Network slice subnet placement 180 of SMO 180 determines one or more requirements for a RAN slice subnet for deployment in mobile network 120. In some examples, the one or more requirements are performance requirements for, e.g., RU PNFs, cell sites, transport links, edge cloud data centers, or regional cloud data centers.

In some examples, network slice subnet placement 180 determines a predicted resource usage by the network slice subnet of a plurality of RU PNFs, a plurality of cell sites, a plurality of edge cloud data centers, and a plurality of regional cloud data centers based on historical telemetry for the mobile network. In this example, network slice subnet placement 180 determines the one or more requirements for the network slice subnet based at least in part on the predicted resource usage by the network slice subnet.

In some examples, network slice subnet placement 180 receives information from various elements of mobile network 120, and may analyze such information to determine the requirements of the network slice subnet and the capacity and/or capabilities of the various elements of mobile network 120. For example, network slice subnet placement 180 may receive information specifying one or more radio performance metrics (PMs) or radio key performance indicators (KPIs) for RU PNFs, base stations 106, and cell sites from, e.g., non-RT RIC 122, near-RT RIC 124, or a RAN network function management function (RAN NFMF) of RAN 109. In addition, network slice subnet placement 180 may receive information specifying compute, storage, and networking resources of edge cloud data centers 110 and/or regional could datacenters 111 from, e.g., an Infrastructure Management Service (IMS) of edge cloud data centers 110 and/or regional could datacenters 111. Further, network slice subnet placement 180 may receive information specifying link telemetry for a first plurality of links that interconnect the cell sites and edge cloud data centers 110 and for a second plurality of links that interconnect edge cloud data centers 110 and regional cloud data centers 111 from, e.g., a Transport NSSMF of mobile network 120. Network slice subnet placement 180 may determine the one or more requirements for the network slice subnet based at least in part on the various information received for the elements of mobile network 120 described herein.

In some examples, network slice subnet placement 180 may determine the one or more requirements for the network slice subnet based at least in part on a network slice subnet template (NSST) for the network slice subnet or a network slice template (NST) for a network slice including the network slice subnet. For example, an NST or NSST may specify performance requirements, types of network functions, or a location in which network functions may be placed, in order to realize the network slice or network slice subnet.

In some examples, network slice subnet placement 180 may determine the one or more requirements for the network slice subnet based at least in part on one or more tracking areas to which the network slice subnet is to be deployed. For example, an NST or NSST may specify that the network slice subnet is to be provisioned within one or more tracking areas. Network slice subnet placement 180 may determine the one or more tracking areas necessitate the use of particular RU PNFs or cell sites in order to realize the network slice or network slice subnet.

In some examples, network slice subnet placement 180 may determine the one or more requirements for the network slice subnet based at least in part on one or more SLA requirements to be satisfied by the RU PNFs, cell sites, edge cloud data centers 110, regional cloud data centers 111, and/or various links providing interconnectivity therebetween, as a prerequisite to deployment of the network slice subnet. For example, SLA requirements for the network slice subnet may require that RU PNFs adhere to certain radio performance requirements, that edge cloud data centers 110 regional cloud data centers 111 support particular virtualization, transport, or compute requirements, or that links satisfy network performance requirements such as jitter, latency, and bandwidth requirements.

Network slice subnet placement 180 identifies one or more RU PNFs of base stations 106 of FIG. 1A that satisfy the one or more requirements for the network slice subnet. From a plurality of cell sites of mobile network 120 hosting the identified one or more RU PNFs, network slice subnet placement 180 identifies one or more cell sites (not depicted in FIG. 1B) of the plurality of cell sites that satisfy the one or more requirements for the network slice subnet. Based on the identified one or more cell sites, network slice subnet placement 180 identifies one or more edge cloud data centers 110 of a plurality of edge cloud data centers 110 of mobile network 120 that satisfy the one or more requirements for the network slice subnet. In some examples, each edge cloud data center of the plurality of edge cloud data centers hosts O-DUs 148 and O-CUs 146 for the RU PNFs.

Based on the identified edge cloud data centers, network slice subnet placement 180 identifies one or more regional cloud data centers 111 of a plurality of regional cloud data centers 111 of mobile network 120 that satisfy the one or more requirements for the network slice subnet. In some examples, network slice subnet placement 180 identifies one or more first links (e.g., edge transport links) of a plurality of first links that interconnect the identified one or more cell sites and the identified one or more edge cloud data centers that satisfy the one or more requirements for the network slice subnet. Network slice subnet placement 180 may further identify one or more second links (e.g., regional transport links) of a plurality of second links that interconnect the identified one or more edge cloud data centers and the identified one or more regional cloud data centers that satisfy the one or more requirements for the network slice subnet.

In some examples, network slice subnet placement 180 identifies the one or more RU PNFs, the one or more cell sites, the one or more edge cloud data centers 110, the one or more regional cloud data centers 111, the edge transport links that interconnect the identified one or more cell sites and the identified one or more edge cloud data centers, and the regional transport links that interconnect the identified one or more edge cloud data centers and the identified one or more regional cloud data centers, based at least in part on a determination that each satisfies one or more SLA requirements corresponding to the element prerequisite to deployment of the network slice subnet.

In some examples, network slice subnet placement 180 identifies the one or more RU PNFs, the one or more cell sites, the one or more edge cloud data centers 110, the one or more regional cloud data centers 111, the edge transport links that interconnect the identified one or more cell sites and the identified one or more edge cloud data centers, and the regional transport links that interconnect the identified one or more edge cloud data centers and the identified one or more regional cloud data centers, based at least in part on a determination that a current resource availability of the corresponding element satisfies a current resource requirement of the network slice subnet.

In some examples, network slice subnet placement 180 identifies the one or more RU PNFs, the one or more cell sites, the one or more edge cloud data centers 110, the one or more regional cloud data centers 111, the edge transport links that interconnect the identified one or more cell sites and the identified one or more edge cloud data centers, and the regional transport links that interconnect the identified one or more edge cloud data centers and the identified one or more regional cloud data centers, based at least in part on a determination that a current resource availability of the corresponding element satisfies a predicted resource requirement of the network slice subnet.

Network slice subnet placement 180 provisions the identified one or more RU PNFs and one or more of the identified one or more cell sites, the identified one or more edge cloud data centers, the identified one or more first links, the identified one or more regional cloud data centers, and the identified one or more second links, to provision the network slice subnet.

In the foregoing example of FIG. 1B, network slice subnet placement 180 provisions elements including RU PNFs, cell sites, edge cloud data centers, first links interconnecting the cell sites and the edge cloud data centers, regional cloud data centers, and second links interconnecting the edge cloud data centers and the regional cloud data centers, to provision the network slice subnet. However, it should be understood that, in accordance with the techniques of the disclosure, network slice subnet placement 180 may operate to provision elements within only a single layer of the mobile network to provision the network slice subnet, such as only elements within the RU PNF layer, the cell site layer, the edge cloud data center layer, the regional cloud data center layer, and/or links in between, as well as any combination of layers of the mobile network to provision the network slice subnet. For example, network slice subnet placement 180 may provision only RU PNFs and cell sites to provision to provision the network slice subnet. As another example, network slice subnet placement 180 may provision only cell sites, edge cloud data centers, and links interconnecting the cell sites and the edge cloud data centers to provision to provision the network slice subnet. As another example, network slice subnet placement 180 may provision only edge cloud data centers, regional cloud data centers, and links interconnecting the edge cloud data centers and the regional cloud data centers to provision to provision the network slice subnet.

FIG. 1C is a block diagram illustrating further example details of the Near-RT RIC of FIG. 1A. In the example illustrated in FIG. 1C, near-RT RIC 124 includes shared data layer 188, database 189, one or more AI/ML models 190, managers 191, xApp subscription manager 192, messaging infrastructure 193, conflict mitigation 194, security 195, xApp repository 196, message bus 187, API enablement 197, and open interfaces, such as O1 termination 185, OAM termination 270, A1 termination 186, Y1 termination 198, and E2 termination 199.

Near-RT RIC 124 can provide near-real-time (e.g., milliseconds) control and optimization of RAN elements and resources, such as O-CU 146, O-DU 148, via fine-grained data collection and actions performed via E2 interface 199. For example, near-RT RIC 124 may onboard one or more applications 125 (e.g., xApps 125A–125N of FIG. 1C, collectively, “xApps 125”) that provide near-real time control of RAN elements and their resources.

Near-RT RIC 124 may be deployed as a highly scalable, microservices based containerized architecture. Near-RT RIC 124 may onboard one or more applications, e.g., applications 125 (e.g., xApps 125) that manage near-real time events within near-RT RIC 124. Applications 125 may leverage the functionality exposed via the near-RT RIC framework of near-RT RIC 124. Near-RT RIC 124 may enforce policies received from applications 123 of non-RT RIC 122 and may provide policy feedback to non-RT RIC 122. Although illustrated as within near-RT RIC 124, any one or more of applications 125 may be executed by a third party, separate from near-RT RIC 124.

Shared Data Layer 188 and database 189 enable near-RT RIC 124 to maintain and expose RAN/UE information and other information required to support specific use cases. In some examples, database 189 maintains a list of UEs and associated data, and perform tracking and correlation of the UE identities associated with the connected E2 Nodes. In some examples, database 189 maintains configurations and near real-time information relating to connected E2 Nodes and the mappings between them. In some examples, Shared Data Layer 188 and database 189. Such information may be generated and accessed by near-RT RIC 124 or authorized xApps 125. Shared Data Layer 188 provides SDL services for xApps 125, which can be used to subscribe to database notifications and to read, write and modify information stored on database 189. Use-case specific information may be exposed using the services provided by Shared Data Layer 188.

Managers 191 include OAM management, which provides fault, configuration, accounting, performance, file, security and other management plane services. Managers 191 of near-RT RIC 124 provide several capabilities to support OAM management services. For example, managers 191 provide fault management, including Near-RT RIC Fault Supervision MnS over the O1 interface. Further, managers 191 provide configuration management, including Near-RT RIC Provisioning MnS over the O1 interface.

In some examples, managers 191 perform logging, tracing, and metrics collection functions. Logging is to capture information needed to operate, troubleshoot and report on the performance of near-RT RIC 124 and its constituent components. Log records may be viewed and consumed directly by users and systems, indexed and loaded into a data storage, and used to compute metrics and generate reports. Near-RT RIC components log events according to a common logging format. Different logs can be generated (e.g., audit log, metrics log, error log and debug log). Tracing mechanisms are used to monitor the transactions or a workflow. An example subscription workflow can be broken into two traces namely, a subscription request trace followed by a response trace. Individual traces can be analyzed to understand timing latencies as the workflow traverses a particular Near-RT RIC component. Metrics are collected and reported for performance and fault management specific to each xApp logic and other internal functionalities are collected and published for authorized consumer (e.g., SMO).

Near-RT RIC 124 includes xApp subscription manager 192. xApp subscription manager 192 enables near-RT RIC 124 to handle subscription requests from different xApps 125 for, e.g., E2-related data, and provides unified data distribution to xApps 125 for those data. xApp subscription manager 192, in some examples, manages subscriptions from xApps to E2 nodes. xApp subscription manager 192 may enforce authorization of policies controlling xApp 125 access to messages. Further, xApp subscription manager 192 enables merging of identical subscriptions from different xApps 125 into a single subscription toward an E2 Node.

Conflict mitigation 194 enables near-RT RIC 124 to detect and resolve potentially overlapping or conflicting requests from multiple xApps 125. In the context of near-RT RIC 124, conflict mitigation 194 addresses conflicting interactions between different xApps 125. An application may change one or more parameters with the objective of optimizing a specific metric. Conflict mitigation 194 may reduce, mitigate, or avoid instances wherein xApps 125 chose or configure objectives such that they result in conflicting actions.

Messaging infrastructure 193 enables near-RT RIC 124 with low-latency message delivery between Near-RT RIC internal endpoints. Messaging infrastructure 193 supports registration of endpoints, wherein endpoints register themselves to messaging infrastructure 193. Messaging infrastructure 193 further supports discovery of endpoints, wherein endpoints are discovered by messaging infrastructure 193 initially and registered to messaging infrastructure 193. Messaging infrastructure 193 also supports deletion of endpoints, wherein endpoints are deleted once they are not used anymore. Messaging infrastructure 193 may provide an API for sending messages to messaging infrastructure 193 and an API for receiving messages from messaging infrastructure 193. Messaging infrastructure 193 supports multiple messaging modes, e.g., point-to-point mode (e.g., message exchange among endpoints), publish/subscribe mode (e.g., real-time data dispatching from E2 termination 199 to multiple subscriber xApps 125). Messaging infrastructure 193 provides message routing, namely according to the message routing information, messages can be dispatched to different endpoints. Messaging infrastructure 193 supports message robustness to avoid data loss during a messaging infrastructure outage/restart or to release resources from the messaging infrastructure once a message is outdated.

Near-RT RIC 124 includes security 195. Security 195 prevent malicious xApps 125 from abusing radio network information (e.g., exporting to unauthorized external systems) and/or control capabilities over RAN functions.

Near-RT RIC 124 includes termination for various interfaces, including E2 termination 199, A1 termination 186, O1 termination 185, OAM termination 270, and Y1 termination 198. E2 termination 199 enables termination of an E2 interface. E2 termination 199 may terminate an SCTP connection from each E2 Node. E2 termination 199 may also route messages from xApps 125 through the SCTP connection to an E2 Node. E2 termination 199 may further decode the payload of an incoming ASN.1 message enough to determine message type. In some examples, E2 termination 199 handles incoming E2 messages related to E2 connectivity and receives and responds to an E2 Setup Request from an E2 Node. Furthermore, E2 termination 199 may notify xApps 125 of a list of RAN functions supported by an E2 Node based on information derived from the E2 Setup and RIC Service Update procedures, and may notify the newly connected E2 Node of the list of accepted functions.

A1 termination 186 enables termination of the A1 interface. A1 termination 186 provides a generic API by means of which Near-RT RIC 124 can receive and send messages via an A1 interface. These include, e.g., A1 policies and enrichment information received from Non-RT RIC 122, or A1 policy feedback sent towards Non-RT RIC 122. A1 termination 186 may further send an A1 policy that is set or updated by Non-RT RIC 122 to suitable xApp(s) 125 based on a list of candidate xApps 125 provided by xApp Repository 196.

O1 termination 185 enables termination of O1 interface 166. Near-RT RIC 124 communicates with SMO 112 via O1 interface 166 and exposes O1-related management services from Near-RT RIC 124. For O1 management services (MnS), near-RT RIC 124 is an MnS producer and SMO 112 is an MnS consumer. Near-RT RIC 124 exposes provisioning management services from Near-RT RIC 124 to an O1 provisioning management service consumer, translates O1 management services to internal APIs of near-RT RIC 124, exposing FM services to report faults and events from near-RT RIC 124 to an O1 FM service consumer, exposes PM services to report bulk and real-time PM data from near-RT RIC 124 to an O1 PM service consumer, exposes file management services to download ML files, software files, etc. and upload log/trace files to/from file MnS consumer, and exposes communication surveillance services to the O1 communication surveillance service consumer.

Y1 termination 198 enables termination of the Y1 interface. Y1 termination 198 provides support for exposing RAN analytics information from Near-RT RIC 124 to Y1 consumers.

Near-RT RIC 124 may include one or more managers to process the O1, A1, Y1, and E2 services, and other services. Near-RT RIC 124 may include other managers, such as an application manager and an application on-boarder, that are configured to manage the installation and deployment of applications 125.

API enablement 197 provide APIS for near-RT RIC 124. The near-RT RIC APIs can be categorized based on the interaction with near-RT RIC 124 and can be related to E2-related services, A1-related services, Management related services, and SDL services. This functionality provides support for registration, discovery and consumption of near-RT RIC APIs within the near-RT RIC scope. In particular, API enablement 197 provides services including repository and registry services for near-RT RIC APIs, services that allow discovery of the registered near-RT RIC APIs, services to authenticate xApps 125 for use of the near-RT RIC APIs, services that enable generic subscription and event notification, and functionality to avoid compatibility clashes between xApps 125 and the services they access. In some examples, API enablement 197 provides API enablement services that are accessed by xApps 125 via one or more enablement APIs.

AI/ML models 190 enables near-RT RIC 124 with data pipelining, model management, training and inference, which constitute complete AI/ML workflow support for xApps 125 to implement AI/ML algorithms. xApps 125 may use none, part, or all of this functionality, depending on its design. In some examples, AI/ML models 190 include data pipelining, which performs data ingestion and preparation for xApps 125. AI/ML models 190 may provide generic and use case-independent capabilities to AI/ML-based xApps 125 that may be useful to multiple use cases. The input data for training may come from an xApp-specific space (e.g., dedicated space in database).

xApp Repository 196 maintaining a list of candidate xApp(s) to A1 Termination 186 for sending A1 policy or policy update to suitable xApp(s) 125 based on policy type and operator policies. In addition, xApp Repository 196 maintains the policy types supported in near-RT RIC 124. The supported policy types are based on policy types supported by the registered xApps 125 and operator policies. Further, xApp Repository 196 performs xApp access control to requested A1-EI type based on operator policies.

Much as described above with respect to FIGS. 1A–1B, in accordance with the techniques of the disclosure, SMO 112 includes network slice subnet placement 180, which selects resources that may be used to provision a network slice subnet within mobile network 120. Network slice subnet placement 180 of SMO 180 determines one or more requirements for a RAN slice subnet for deployment in mobile network 120.

Network slice subnet placement 180 identifies one or more RU PNFs of base stations 106 that satisfy the one or more requirements for the network slice subnet. From a plurality of cell sites of mobile network 120 hosting the identified one or more RU PNFs of base stations 106, network slice subnet placement 180 identifies one or more cell sites of the plurality of cell sites that satisfy the one or more requirements for the network slice subnet.

Based on the identified one or more cell sites, network slice subnet placement 180 identifies one or more edge cloud data centers 110 of a plurality of edge cloud data centers 110 of mobile network 120 that satisfy the one or more requirements for the network slice subnet. Based on the identified edge cloud data centers, network slice subnet placement 180 identifies one or more regional cloud data centers 111 of a plurality of regional cloud data centers 111 of mobile network 120 that satisfy the one or more requirements for the network slice subnet. In some examples, network slice subnet placement 180 identifies one or more first links (e.g., edge transport links) of a plurality of first links that interconnect the identified one or more cell sites and the identified one or more edge cloud data centers that satisfy the one or more requirements for the network slice subnet. Network slice subnet placement 180 may further identify one or more second links (e.g., regional transport links) of a plurality of second links that interconnect the identified one or more edge cloud data centers and the identified one or more regional cloud data centers that satisfy the one or more requirements for the network slice subnet.

Network slice subnet placement 180 provisions the identified one or more RU PNFs, the identified one or more cell sites, the identified one or more edge cloud data centers, the identified one or more first links, the identified one or more regional cloud data centers, and the identified one or more second links, to provision the network slice subnet. While in the foregoing example, network slice subnet placement 180 provisions a RAN slice subnet, in other examples, network slice subnet placement 180 may provision a transport network slice subnet, a core network slice subnet, or an end-to-end network slice spanning the RAN, transport, and core networks using the techniques described herein.

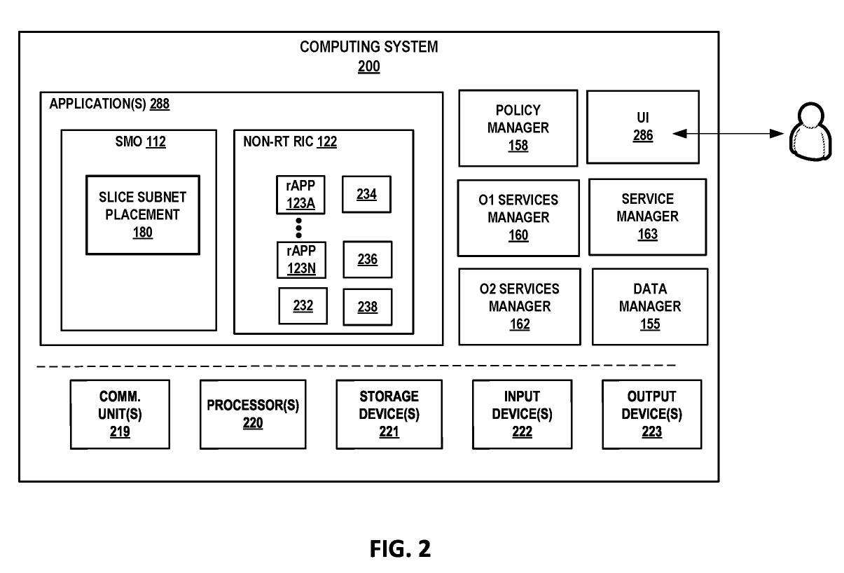

FIG. 2 is a block diagram illustrating example computing system 200 in detail, in accordance with techniques of this disclosure. In this example of FIG. 2, computing system 200 may implement, for example, an SMO 112 and/or a non-real time RIC, such as non-RT RIC 122 of FIGS. 1A–1C. While computing system 200 of FIG. 2 is depicted with respect to non-RT RIC 122 of FIGS. 1A–1C, a computing system, such as computing system 200, may also implement near-RT RIC 124 of FIGS. 1A–1C in a substantially similar fashion.

Computing system 200 includes processing circuitry 220, one or more input devices 222, one or more output devices 223, one or more communication units 219, and one or more storage device(s) 221. In some examples, computing system 200 is a cloud computing system, server farm, and/or server cluster (or portion thereof) that provides services to client devices and other devices or systems. In other examples, computing system 200 may be implemented through one or more virtualized compute instances (e.g., virtual machines, containers) of a data center, cloud computing system, server farm, and/or server cluster.

One or more of the devices, modules, storage areas, or other components of computing system 200 may be interconnected to enable inter-component communications (physically, communicatively, and/or operatively). In some examples, such connectivity may be provided by communication channels, a system bus (e.g., message bus 151 of FIG. 1B), a network connection, an inter-process communication data structure, or any other method for communicating data.

Processing circuitry 220 of computing system 200 may implement functionality and/or execute instructions associated with an SMO and/or a non-RT RIC or associated with one or more modules illustrated herein and/or described herein, including applications 288, policy manager 158, O1 services manager 160, O2 services manager 162, service manager 163, and data manager 155. Processing circuitry 220 may be, may be part of, and/or may include processing circuitry that performs operations in accordance with one or more aspects of the present disclosure. Examples of processing circuitry 220 include microprocessors, application processors, display controllers, auxiliary processors, one or more sensor hubs, and any other hardware configured to function as a processor, a processing unit, or a processing device. Computing system 200 may use processing circuitry 220 to perform operations in accordance with one or more aspects of the present disclosure using software, hardware, firmware, or a mixture of hardware, software, and firmware residing in and/or executing at computing system 200. Any one or more of applications 288, policy manager 158, O1 services manager 160, O2 services manager 162, service manager 163, and data manager 155 may be hosted by a cloud provider or other third-party.

One or more communication units 219 of computing system 200 may communicate with devices external to computing system 200 by transmitting and/or receiving data, and may operate, in some respects, as both an input device and an output device. In some examples, communication units 219 may communicate with other devices over a network. In other examples, communication units 219 may send and/or receive radio signals on a radio network such as a cellular radio network. In other examples, communication units 219 of computing system 200 may transmit and/or receive satellite signals on a satellite network such as a Global Positioning System (GPS) network. Examples of communication units 219 include a network interface card (e.g., an Ethernet card), an optical transceiver, a radio frequency transceiver, a GPS receiver, or any other type of device that can send and/or receive information. Other examples of communication units 219 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 222 may represent any input devices of computing system 200 not otherwise separately described herein. One or more input devices 222 may generate, receive, and/or process input from any type of device capable of detecting input from a human or machine. For example, one or more input devices 222 may generate, receive, and/or process input in the form of electrical, physical, audio, image, and/or visual input (e.g., peripheral device, keyboard, microphone, camera).

One or more output devices 223 may represent any output devices of computing system 200 not otherwise separately described herein. One or more output devices 223 may generate, receive, and/or process input from any type of device capable of detecting input from a human or machine. For example, one or more output devices 223 may generate, receive, and/or process output in the form of electrical and/or physical output (e.g., peripheral device, actuator). In some examples, output devices 223 provide UI 286 with which an administrator may interact with computing system 200.

One or more storage device(s) 221 within computing system 200 may store information for processing during operation of computing system 200. Storage device(s) 221 may store program instructions and/or data associated with one or more of the modules described in accordance with one or more aspects of this disclosure. Processing circuitry 220 and one or more storage device(s) 221 may provide an operating environment or platform for such modules, which may be implemented as software, but may in some examples include any combination of hardware, firmware, and software. Processing circuitry 220 may execute instructions and one or more storage device(s) 221 may store instructions and/or data of one or more modules. The combination of processing circuitry 220 and storage device(s) 221 may retrieve, store, and/or execute the instructions and/or data of one or more applications, modules, or software. Processing circuitry 220 and/or storage device(s) 221 may also be operably coupled to one or more other software and/or hardware components, including, but not limited to, one or more of the components of computing system 200 and/or one or more devices or systems illustrated as being connected to computing system 200.

In some examples, one or more storage device(s) 221 are temporary memories, meaning that a primary purpose of the one or more storage devices is not long-term storage. Storage device(s) 221 of computing system 200 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage device(s) 221, in some examples, also include one or more computer-readable storage media. Storage device(s) 221 may be configured to store larger amounts of information than volatile memory. Storage device(s) 221 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

Applications 288 may include SMO 112 and rApps 123A. SMO 112 provides orchestration, control management, and automation aspects of RAN 109 (e.g., network slicing, management, and orchestration of O-Cloud, etc.). Further, SMO 112 may control aspects of non-RT RIC 122 of FIGS. 1A–1C and near-RT RIC 124 of FIGS. 1A–1C.

As described above, rApps 123 may manage non-real time events within non-RT RIC 122, such as applications that do not require response times of less than one second. rApps 123 may leverage the functionality exposed via a non-RT RIC framework of computing device 200. rApps 123 may be used to control and manage RAN elements and resources, such as a near-RT RIC, RAN nodes, and/or resources in the O-RAN cloud. rApps 123 may provide one or more services that are performed using interfaces of computing system 200 (e.g., management interfaces such as the A1 interface, O1 interface, O2 interface, OAM interface etc.). Examples of rApps 123 may include, e.g., services such as policies 1 for a near-RT RIC, configuration instructions 234 for O-RAN managed elements, performance jobs 236 for O-RAN managed elements, services for managing the services and/or data 238, etc.

Computing system 200 may include one or more modules or units configured to perform one or more services or functions of applications 288, such as policy manager 158, O1 services manager 160, O2 services manager 162, service manager 163, and data manager 155, as described above.

For example, policy manager 158 is configured to control the deployment of policies (e.g., A1 services). For example, policy manager 158 may receive requests for A1 services from applications 123 (e.g., via R1 interface 154 of FIG. 1B), process the A1 services from applications 123, and perform the A1 services for a near-RT RIC using an A1 interface (e.g., A1 interface 164 of FIG. 1B). In some examples, the A1 interface may implement an A1AP application protocol based on the 3GPP framework.

O1 services manager 160 is configured to control the deployment of O1 services for monitoring the performance of O-RAN managed elements (e.g., near-RT RIC 124, O-CU 146, O-DU 148 of FIG. 1B). For example, O1 services manager 160 may receive requests for O1 services for monitoring the performance of the near-RT RIC from applications 123 (e.g., via R1 interface 154 of FIG. 1B), process the O1 services, and perform the O1 services for the O-RAN managed elements using an O1 interface (e.g., O1 interface 166 of FIG. 1B). In some examples, the O1 interface may implement REST/HTTPS APIs and/or NETCONF.

O1 services manager 160 is additionally, or alternatively, configured to control the deployment of O1 services for the configuration of near-RT RIC 124 and/or RAN nodes. For example, O1 services manager 160 may receive requests for O1 services for the configuration of O-RAN managed elements from applications 123 (e.g., via R1 interface 154 of FIG. 1B), process the O1 services, and may perform the O1 services for the O-RAN managed elements using an O1 interface (e.g., O1 interface 166 of FIG. 1B).

O2 services manager 162 may be configured to control the deployment of O2 services for monitoring the performance of resources of the O-RAN cloud. For example, O2 services manager 162 may receive requests for O2 services for monitoring the performance of resources within the O-RAN cloud (e.g., via R1 interface 154 of FIG. 1B), process the O2 services, and may perform the O2 services for the resources of the O-RAN cloud using an O2 interface (e.g., O2 interface 167 of FIG. 1B).

O2 services manager 162 may additionally, or alternatively, be configured to control the deployment of O2 services for the configuration of resources of the O-RAN cloud. For example, O2 services manager 162 may receive requests for O2 services for configuring resources within the O-RAN cloud from applications 123 (e.g., via R1 interface 154 of FIG. 1B), process the O2 services, and may perform the O2 services for the resources of the O-RAN cloud using an O2 interface (e.g., O2 interface 167 of FIG. 1B).

Service manager 163 is configured to manage services, such as registration of a service, update of a service registration, service discovery, etc. For example, service manager 163 may receive requests for SME services from applications 123 (e.g., via R1 interface 154 of FIG. 1B), perform the SME service (e.g., register/update a service) for one or more applications 123, and send a response to the one or more applications 123 using an R1 interface (e.g., R1 interface 154 of FIG. 1B).

Data manager 155 is configured to manage the data of applications 123. For example, data manager 155 may receive requests for DME services from applications 123 (e.g., via R1 interface 154 of FIG. 1B), perform the DME services (e.g., sending data from application configured as a data producer to application configured as a data consumer) for one or more applications 123, and send a response to the one or more applications 123 using an R1 interface (e.g., R1 interface 154 of FIG. 1B).

In accordance with the techniques of the disclosure, computing system 200 executes network slice subnet placement 180, which selects resources that may be used to provision a network slice subnet within mobile network 120. In some examples, network slice subnet placement 180 is part of SMO 112 (or a component thereof). In some examples, network slice subnet placement 180 is executed as an rApp 123 of non-RT RIC 122. While note depicted in the example of FIG. 2, in other examples, network slice subnet placement 180 may be executed as an xApp of near-RT RIC 124 or as a RAN NFMF of RAN 109 of FIGS. 1A–1C.

Network slice subnet placement 180 of computing system 200 determines one or more requirements for a RAN slice subnet for deployment in mobile network 120. Network slice subnet placement 180 identifies one or more RU PNFs of base stations 106 that satisfy the one or more requirements for the network slice subnet. From a plurality of cell sites of mobile network 120 hosting the identified one or more RU PNFs of base stations 106, network slice subnet placement 180 identifies one or more cell sites of the plurality of cell sites that satisfy the one or more requirements for the network slice subnet.

Based on the identified one or more cell sites, network slice subnet placement 180 identifies one or more edge cloud data centers 110 of a plurality of edge cloud data centers 110 of mobile network 120 that satisfy the one or more requirements for the network slice subnet. Based on the identified edge cloud data centers, network slice subnet placement 180 identifies one or more regional cloud data centers 111 of a plurality of regional cloud data centers 111 of mobile network 120 that satisfy the one or more requirements for the network slice subnet. In some examples, network slice subnet placement 180 identifies one or more first links (e.g., edge transport links) of a plurality of first links that interconnect the identified one or more cell sites and the identified one or more edge cloud data centers that satisfy the one or more requirements for the network slice subnet. Network slice subnet placement 180 may further identify one or more second links (e.g., regional transport links) of a plurality of second links that interconnect the identified one or more edge cloud data centers and the identified one or more regional cloud data centers that satisfy the one or more requirements for the network slice subnet.

Network slice subnet placement 180 provisions the identified one or more RU PNFs, the identified one or more cell sites, the identified one or more edge cloud data centers, the identified one or more first links, the identified one or more regional cloud data centers, and the identified one or more second links, to provision the network slice subnet. While in the foregoing example, network slice subnet placement 180 provisions a RAN slice subnet, in other examples, network slice subnet placement 180 may provision a transport network slice subnet, a core network slice subnet, or an end-to-end network slice spanning the RAN, transport, and core networks using the techniques described herein.

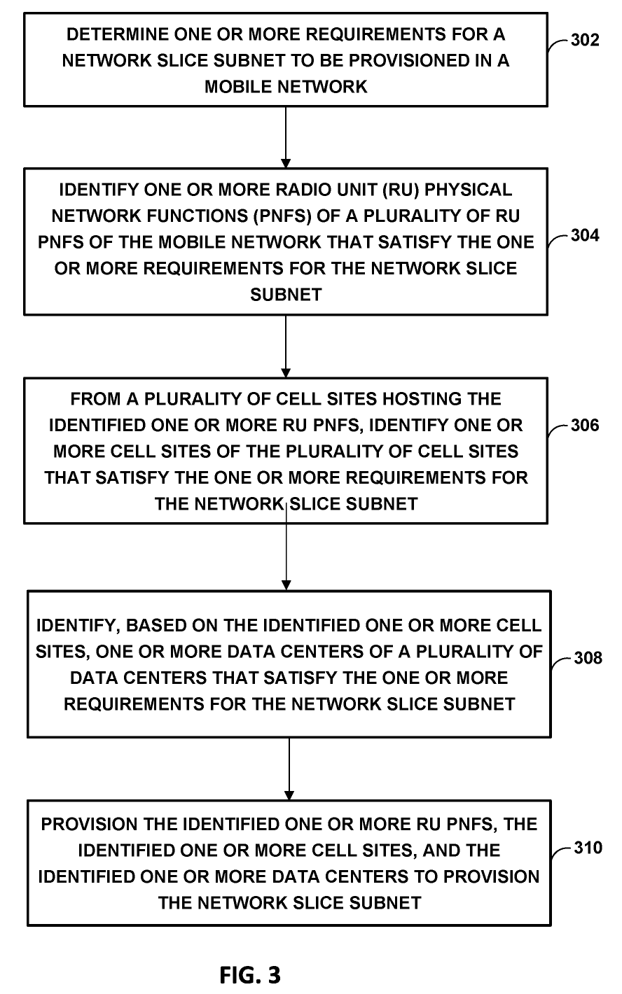

FIG. 3 is a flowchart illustrating an example operation in accordance with the techniques of this disclosure. FIG. 3 is described with respect to computing system 200 of FIG. 2 for convenience. However, the operation of FIG. 3 may also be performed by non-RT RIC 122, near-RT RIC 124 of FIGS. 1A–1C, or by another system.

As depicted in the example of FIG. 3, network slice subnet placement 180 of computing system 200 determines one or more requirements for a RAN slice subnet to be provisioned in mobile network 120 (302). Network slice subnet placement 180 identifies one or more RU PNFs of base stations 106 that satisfy the one or more requirements for the network slice subnet (304). From a plurality of cell sites of mobile network 120 hosting the identified one or more RU PNFs of base stations 106, network slice subnet placement 180 identifies one or more cell sites of the plurality of cell sites that satisfy the one or more requirements for the network slice subnet (306). Based on the identified one or more cell sites, network slice subnet placement 180 identifies one or more data centers of a plurality of data centers (e.g., edge cloud data centers, regional cloud data centers, etc.) that satisfy the one or more requirements for the network slice subnet (308).

In some examples, the one or more data centers are one or more edge cloud data centers 110. Optionally, based on the identified edge cloud data centers, network slice subnet placement 180 identifies one or more regional cloud data centers 111 of a plurality of regional cloud data centers 111 of mobile network 120 that satisfy the one or more requirements for the network slice subnet. In some examples, network slice subnet placement 180 identifies one or more first links (e.g., edge transport links) of a plurality of first links that interconnect the identified one or more cell sites and the identified one or more edge cloud data centers that satisfy the one or more requirements for the network slice subnet. Network slice subnet placement 180 may further identify one or more second links (e.g., regional transport links) of a plurality of second links that interconnect the identified one or more edge cloud data centers and the identified one or more regional cloud data centers that satisfy the one or more requirements for the network slice subnet.

Network slice subnet placement 180 provisions the identified one or more RU PNFs, the identified one or more cell sites, the identified one or more edge cloud data centers, the identified one or more first links, the identified one or more regional cloud data centers, and the identified one or more second links, to provision the network slice subnet (310). As described herein, “provisioning” the identified one or more RU PNFs, the identified one or more cell sites, the identified one or more edge cloud data centers, the identified one or more first links, the identified one or more regional cloud data centers, and the identified one or more second links, to provision the network slice subnet, may include configuring the various elements, deploying one or more network functions within the various elements, allocating resources of or to the various elements, etc. While in the foregoing example, network slice subnet placement 180 provisions a RAN slice subnet, in other examples, network slice subnet placement 180 may provision a transport network slice subnet, a core network slice subnet, or an end-to-end network slice spanning the RAN, transport, and core networks using the techniques described herein.

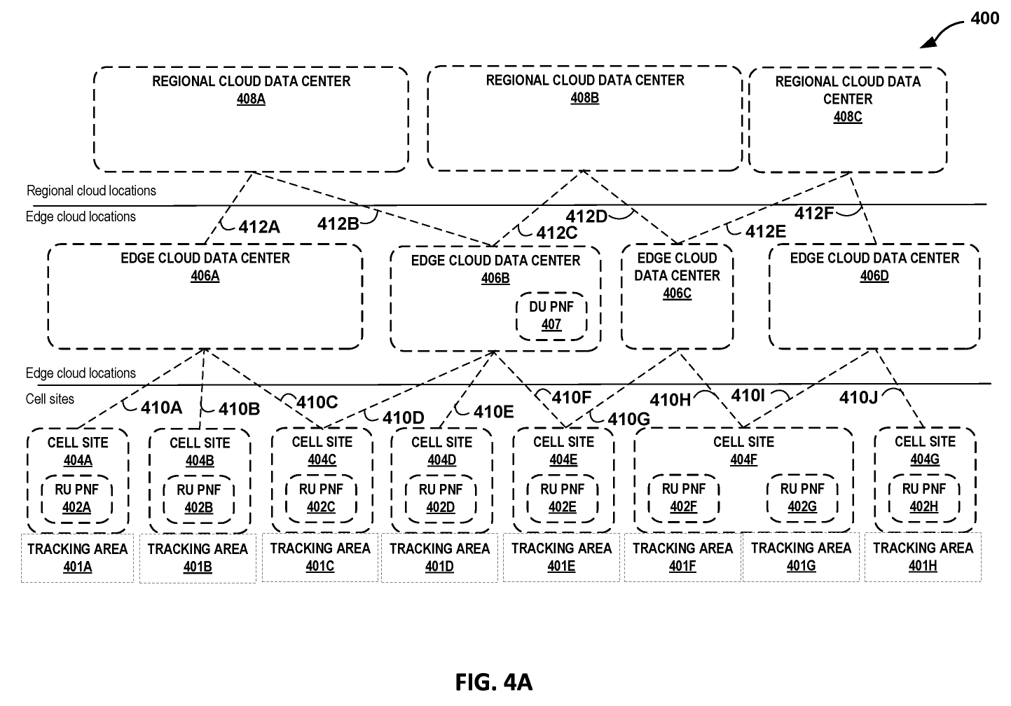

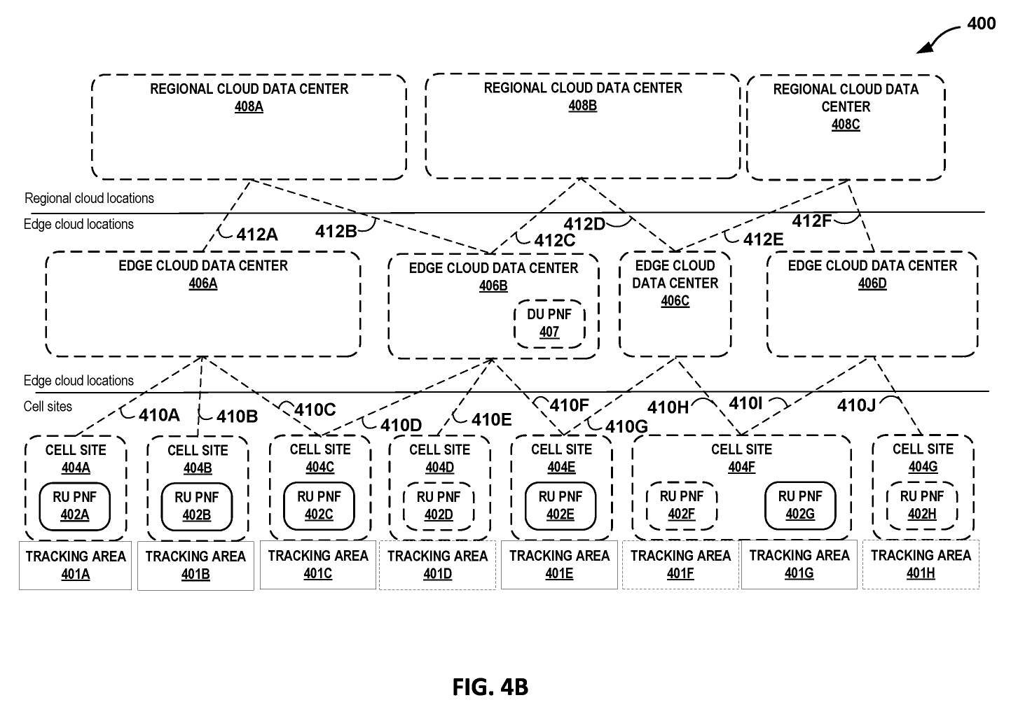

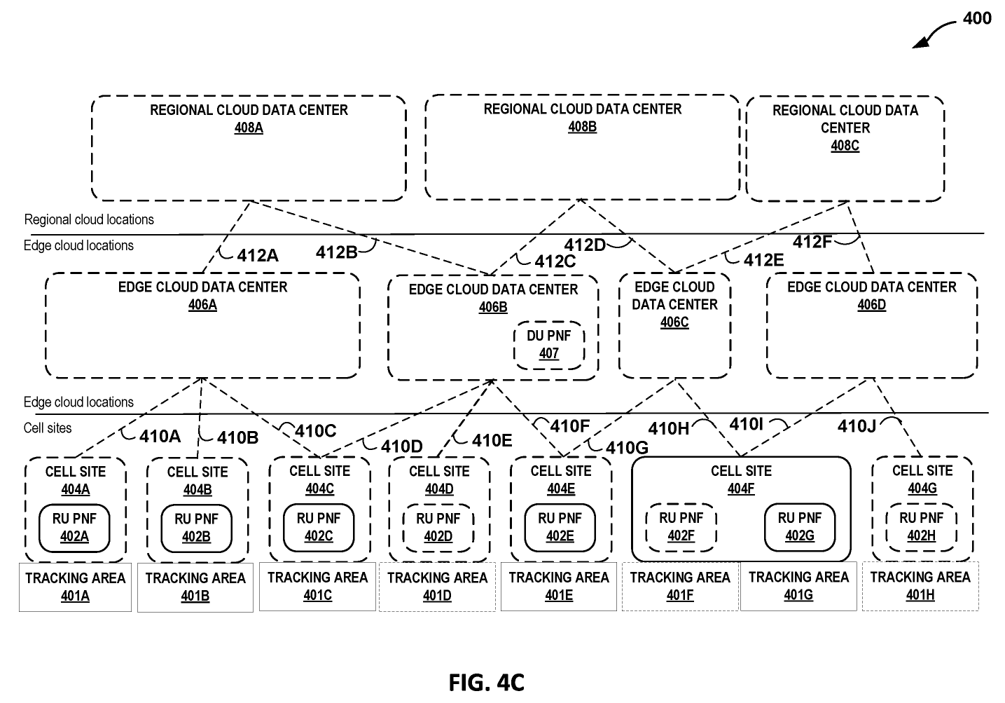

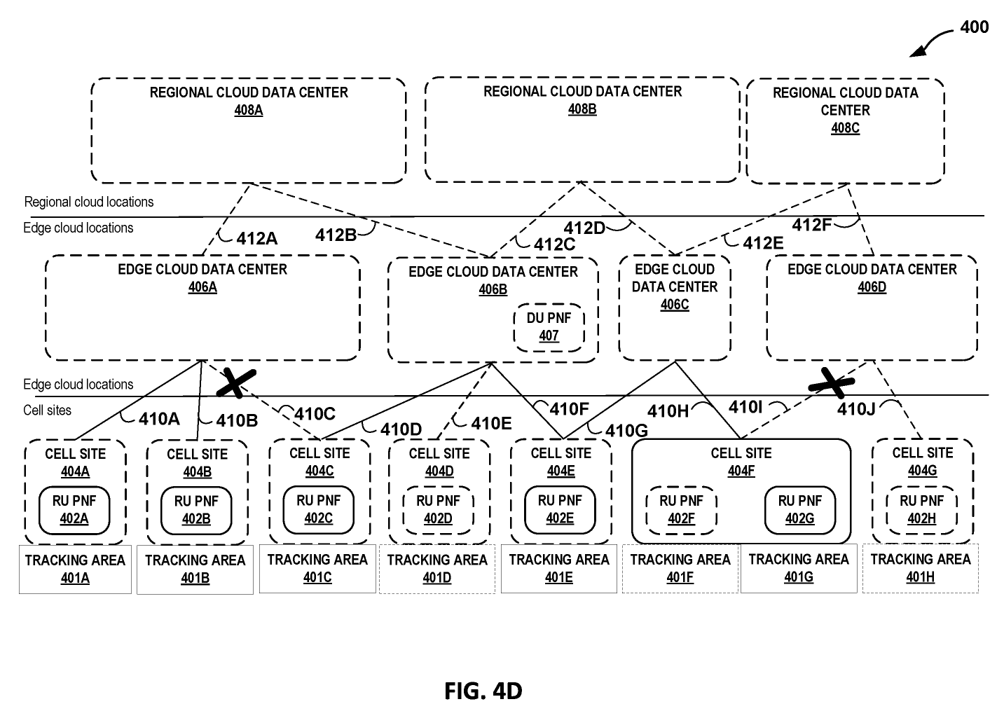

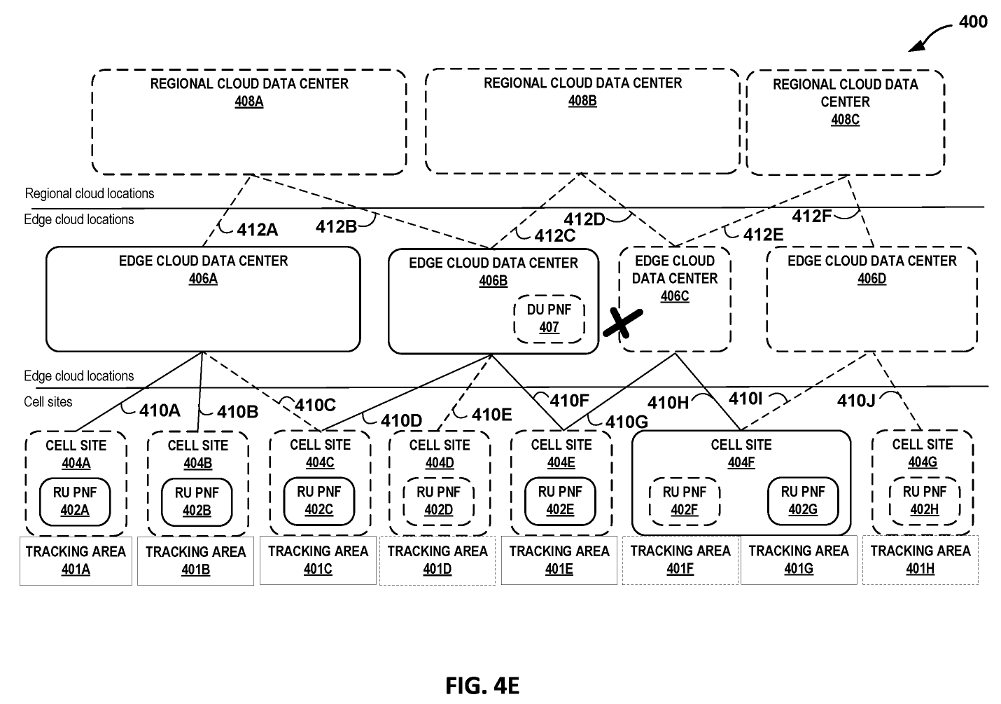

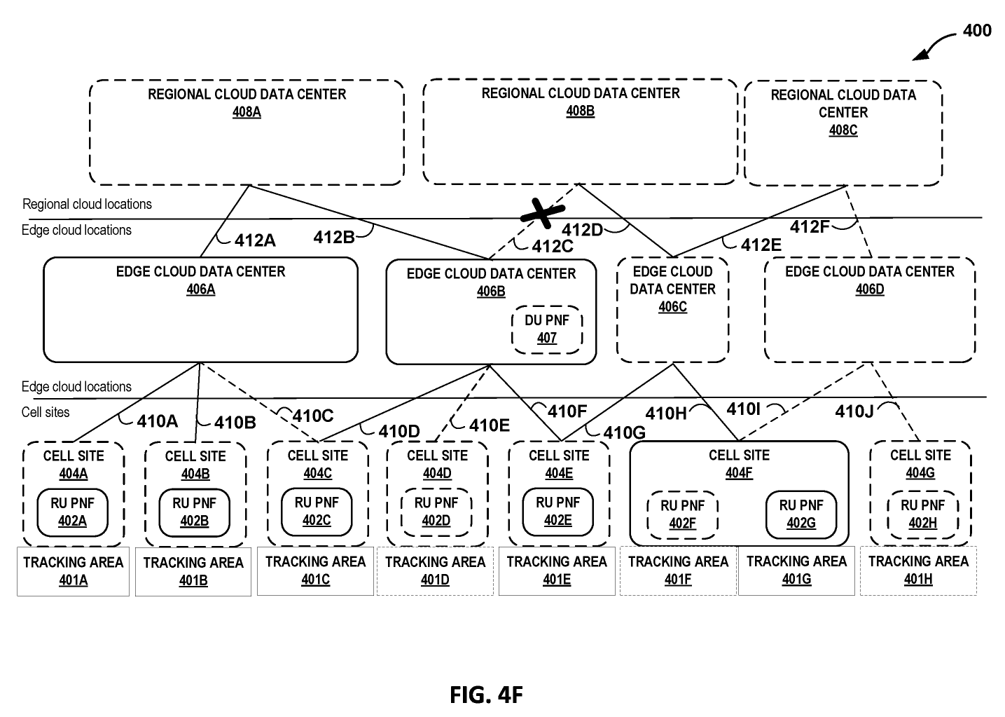

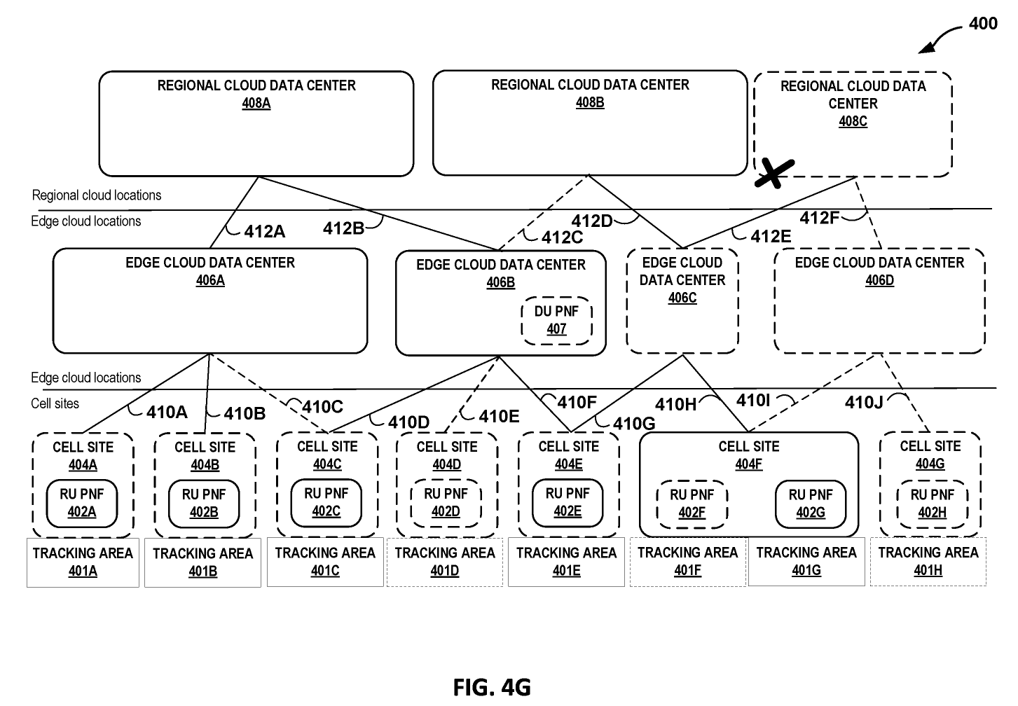

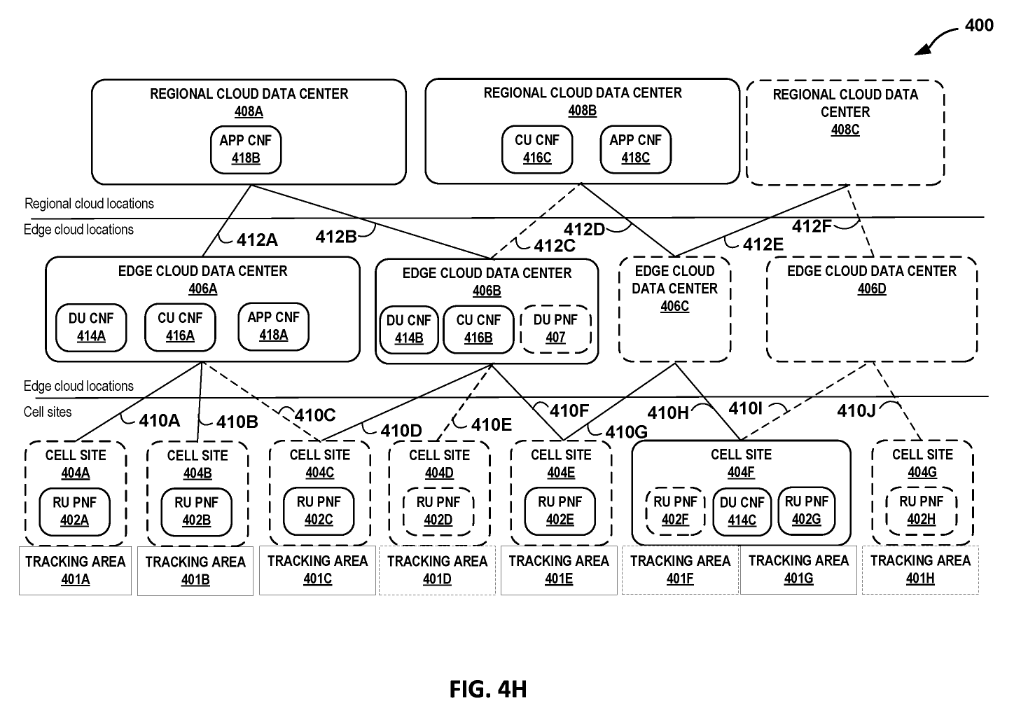

FIGS. 4A–4H are block diagrams illustrating an example operation for provisioning a network slice subnet within a mobile network, in accordance with one or more techniques of the disclosure. More specifically, FIGS. 4A–4H illustrate an example initial (Day-1) NF placement algorithm for RAN Slice Orchestration, in accordance with one or more techniques of the disclosure.

As depicted in FIGS. 4A–4H, a mobile network 400 includes cell sites 404A–404G (collectively, “cell sites 404”), edge cloud data centers 406A–406D (collectively, “edge cloud data centers 406”), and regional cloud data centers 408A–408C (collectively, “regional cloud data centers 408”). In some examples, mobile network 400 is an example of mobile network 120 of FIGS. 1A–1C, edge cloud data centers 406 are examples of edge cloud data centers 110 of FIGS. 1A–1C, and regional cloud data centers 408 are examples of regional cloud data centers 111 of FIGS. 1A–1C.

Cell sites 404 include RU PNFs 402A–402H (collectively, “RU PNFs 402”). RU PNFs 402 may be hosted by, e.g., base stations 106 of FIGS. 1A–1C. Each of RU PNFs 402 may be associated with a corresponding tracking area 401A–401H (collectively, “tracking areas 401”). Edge cloud data centers 406 and regional cloud data centers 408 may host various network functions, such as DU PNF 407, DU cloud native functions (CNF) 414A–414B, CU CNFs 416A–416C, and application CNFs 418A–418C. Links 410A–410J (collectively, “links 410”) provide interconnectivity between cell sites 404 and edge cloud data centers 406. Links 412A–412J (collectively, “links 412”) provide interconnectivity between edge cloud data centers 406 and regional cloud data centers 408.

In accordance with the techniques of the disclosure, network slice subnet placement 180 performs multi-dimensional decisions to iteratively evaluate PMs/Inputs (e.g. topology, etc.) and optimize placement of network slice subnets by taking into account RAN, TN, and DC initial PMs, evaluating the impact of initial placement, and then iteratively optimizing the placement.

As depicted in FIG. 4A, network slice subnet placement 180 performs RAN inventory and topology discovery. As prerequisite for the algorithm described herein, network slice subnet placement 180 discovers the RAN inventory and topology, which includes radio cell sites 404, RU PNFs 402, RAN Tracking Areas 410, cloud locations, sites, and clusters such as edge cloud data centers 406 and regional cloud data centers 408, and inter-cloud transport network links, such as links 410 and 412. In some examples, network slice subnet placement 180 is a RAN NSSMF of RAN 109 of FIGS. 1A–1C.

First, network slice subnet placement 180 performs telemetry collection. Network slice subnet placement 180 may leverage specialized resource managers or controllers for specific sub-network technologies, such as RAN, Transport, and Data Center domains) to collect telemetry about actual resource usage of the elements versus the available capacity of the elements. For example, network slice subnet placement 180 may request radio PMs or KPIs from non-RT RIC 122, near-RT RIC 124, rApps 123, or xApps 125. As another example, network slice subnet placement 180 may request link telemetry from the TN NSSMF (or IETF Network Slice Controller (NSC)). As another example, network slice subnet placement 180 may request data center compute, storage, or networking resources from an O-RAN IMS. As another example, network slice subnet placement 180 may request additional (RAN impacting) telemetry such as UE mobility, etc., from a Network Data Analytics Function (NWDAF) of the core domain). For example, network slice subnet placement 180 may use UE mobility data to predict where UEs are moving within the network so as to forecast upcoming usage patterns. Based on collected telemetry data (current and historical), network slice subnet placement 180 forecasts the future utilization of resources for a variety of technology-specific performance metrics related to radio links, cloud and data center locations, and transport network links.

Next, network slice subnet placement 180 performs a RAN slice subnet feasibility check as depicted in the examples of FIGS. 4A–4H. By performing the RAN slice subnet feasibility check described herein, network slice subnet placement 180 evaluates a feasibility of creating a RAN slice subnet. As described herein, network slice subnet placement 180 uses, as inputs to determine the feasibility of provisioning the RAN slice subnet, information from a variety of sources, including: (1) a RAN Slice Template design, including RAN NFs to include in the slice, their cloud / acceleration requirements, and the networking topology; (2) RAN tracking areas which the RAN Slice should span; (3) RAN Slice SLA requirements, such as, for example, maximum latency, minimum throughput, etc.; (4) discovered RAN inventory and topology (discovered as described above); and/or (5) available resources (current and forecasted) within the radio networks, transport networks, and data centers.

And example of the feasibility check procedure is based on the following logic described below. In the below example, when network slice subnet placement 180 evaluates the capacity of a resource (such as an RU, cloud location or site, transport link, etc.), network slice subnet placement 180 considers a currently-available capacity, as well as a forecasted capacity of the element or resource. In other examples, network slice subnet placement 180 may consider only the current capacity of a resource, while in other examples, network slice subnet placement 180 may consider only the future capacity of a resource.

As a first step of the RAN feasibility check, Based on the RAN slice requirements for tracking area coverage, network slice subnet placement 180 identifies RU PNFs 402 and cell sites 404 to include in the slice from the RAN inventory and topology. Network slice subnet placement 180 ensures that the selected RU PNFs 402 have a capability and a capacity to serve the new slice.

FIG. 4B depicts an example of RU PNF 402 selection based on tracking area. More specifically, FIG. 4B depicts an example of RUs and Cell Sites selection for a slice that requires coverage to Tracking Areas 401A–401C, 401E, and 401G. With respect to the example of FIG. 4B, network slice subnet placement 180 has selected RU PNFs 402A–402C, 402E, and 402G (represented with solid lines).

As a second step of the RAN feasibility check, network slice subnet placement 180 identifies, from the selected RU PNFs 402A–402C, 402E, and 402G of FIG. 4B, hosting cell sites 404 that have virtualization and containerization capabilities (e.g., such as that the cell sites 404 are running a Kubernetes platform), provide acceleration support (if needed by RAN NFs), and provide available capacity to host RAN VNFs or CNFs.

FIG. 4C depicts an example of cell site 404 selection with virtualization capability and/or capacity. More specifically, FIG. 4C depicts an example wherein network slice subnet placement 180 selects cell site 404F (represented with a solid line) as being capable and available for running RAN VNF and CNF required by the network slice. Cell sites 404A–404C and 404E do not have the capability and/or capacity to host the RAN VNFs and CNFs, but may still be used for their RU PNFs. Network slice subnet placement 180 does not consider cell sites 404D or 404G as part of the RAN feasibility check because these cell sites do not host RU PNGs that satisfy the requirements of the network slice.

As a third step of the RAN feasibility check, network slice subnet placement 180 identifies, from the selected RU PNFs 402A–402C, 402E, and 402G and cell site 404F, transport links 410 with capabilities (e.g. traffic engineering, VPN, etc.), and available capacity (e.g. latency, throughput, etc.) to transport the RAN slice traffic.

FIG. 4D depicts an example of transport link 410 selection for cell site to edge clouds. In the example of FIG. 4D, transport links 410A, 410B, 410D, 410F, 410G, 410H (represented with solid lines) can be used to interconnect the slice, while transport links 410C and 410J (annotated with ‘X’) do not satisfy the requirements for capability or capacity for the slice.

As a fourth step of the RAN feasibility check, network slice subnet placement 180 repeats steps 2 and 3 above to evaluate the capability and availability of the edge cloud data centers 406 and regional cloud data centers 408, as well as interconnecting transport links 412, to host the RAN slice with respect to the requirements for provisioning the network slice. This is represented in FIGS. 4E, 4F, and 4G below.

FIG. 4E depicts an example of edge cloud data center 406 selection with virtualization capability and capacity. In the example of FIG. 4D, edge cloud datacenters 406A and 406B (represented with solid lines) satisfy the requirements for provisioning the network slice, while edge cloud data center 406C (annotated with ‘X’) does not. In some examples, even if a given cloud datacenter does not have available resources (e.g. CPU, memory) to host additional VNFs or CNFs, this cloud datacenter may still be used as a bridge in a RAN Slice topology to interconnect transport network links 410, 412 between other ingress or egress cloud data centers. This is represented in FIG. 4E by edge cloud data center 408C. Network slice subnet placement 180 does not consider edge cloud 406D as part of the feasibility check, because neither cell site 404G nor transport link 410I to cell site 404F satisfies the requirements for the network slice.

FIG. 4F depicts an example of selection of transport links 412 between edge cloud data centers 406 and regional cloud data centers 408. In the example of FIG. 4F, transport links 412A, 412C, 412D, and 412E (represented with solid lines) can be used to interconnect the slice, while transport link 412 (annotated with ‘X’) does not satisfy the requirements for capability or capacity for the slice. Network slice subnet placement 180 does not consider transport link 412F as part of the feasibility check, because edge cloud data center 406D was eliminated from the feasibility check during the previous step.

FIG. 4G depicts an example of regional cloud data center 408 selection with virtualization capability and capacity. In the example of FIG. 4G, regional cloud datacenters 408A and 408B (represented with solid lines) satisfy the requirements for provisioning the network slice, while regional cloud data center 408C (annotated with ‘X’) does not.

As a fifth step of the RAN feasibility check, network slice subnet placement 180 evaluates the feasibility of orchestrating the desired RAN Slice based on the set of RU PNFs 402, cell sites 404, edge cloud data centers 406, regional cloud data centers 408, and transport links 410, 412 identified in steps 1–4 above. As part of the determination, network slice subnet placement 180 attempts to instantiate the RAN slice with different placement scenarios that fulfill one or more SLA requirements for the slice and respects the network slice topology.

FIG. 4H depicts an example of a feasibility check for different placement scenarios of the RAN Slice given the elements identified above. More specifically, FIG. 4H represents different placement scenarios for realizing a RAN Slice that has a Network Slice Template design of RU <-> DU <-> CU <-> Application (e.g. Near-RT RIC, Edge application, etc.).

As a sixth step of the RAN feasibility check, network slice subnet placement 180 determines the feasibility of provisioning a network slice within mobile network 400 given the success of steps 1–5 above. If the RAN feasibility check is successful based on both current and forecasted capacity across the RAN, Transport and Cloud domains, then it is feasible to realize the RAN Slice. SMO 112 provisions network slice using the elements and resources identified by network slice subnet placement 180.

If the RAN feasibility check is successful based on current capacity only, but is not successful with respect to forecasted capacity, then network slice subnet placement 180 or SMO 112 may orchestrate the RAN Slice with the risk of SLA violation at runtime (for the current network slice or other competing network slices). In this case, network slice subnet placement 180 or SMO 112 may either: (a) refuse to orchestrate the slice; (b) rely on RAN slice SLA assurance optimization at runtime to resolve SLA violations, if any; or (c) rely on network slice prioritization techniques to de-prioritize lower priority network slices in the case of runtime SLA violation.

If the RAN feasibility check is unsuccessful based on current capacity, then it is not feasible to orchestrate the RAN Slice. In this case, network slice subnet placement 180 or SMO 112 may either: (a) refuse to orchestrate the slice; or (b) rely on network slice prioritization techniques to de-prioritize lower priority network slices to make sufficient capacity for the new desired network slice.

Finally, network slice subnet placement 180 performs RAN slice subnet orchestration. If the result of the feasibility check described above is positive, network slice subnet placement 180 proceeds with orchestration of the RAN slice (across RAN, Transport and Cloud domains) in accordance with the placement scenarios identified above in FIG. 4H.

In some examples, network slice subnet placement 180 perform runtime optimization (Day-2). As described herein, network slice subnet placement 180 implements an NF placement algorithm for RAN Slice optimization procedure as follows: For placement optimization and NF re-location, network slice subnet placement 180 performs reinforced learning to evaluate impact of initial placement. In some examples, network slice subnet placement 180 uses this information to optimize the actual subnet slice placement, which may include relocating NFs to different elements of the mobile network. In some examples, network slice subnet placement 180 uses this information to improve the initial placement of future network slices, other slice orchestration decisions, or other placement decisions.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system comprising processing circuitry having access to a memory, the processing circuitry configured to:
determine one or more requirements for a network slice subnet to be provisioned in a mobile network;
identify one or more Radio Unit (RU) physical network functions (PNFs) of a plurality of RU PNFs of the mobile network that satisfy the one or more requirements for the network slice subnet;
from a plurality of cell sites hosting the identified one or more RU PNFs, identify one or more cell sites of the plurality of cell sites that satisfy the one or more requirements for the network slice subnet;
identify, based on the identified one or more cell sites, one or more data centers of a plurality of data centers that satisfy the one or more requirements for the network slice subnet; and
provision the identified one or more RU PNFs, the identified one or more cell sites, and the identified one or more data centers to provision the network slice subnet.

2. The computing system of claim 1,
wherein the plurality of data centers comprise a plurality of edge cloud data centers, and
wherein the processing circuitry is further configured to:
identify, based on the identified one or more edge cloud data centers, one or more regional cloud data centers of a plurality of regional cloud data centers that satisfy the one or more requirements for the network slice subnet; and
provision the identified one or more regional cloud data centers to provision the network slice subnet.

3. The computing system of claim 2, wherein the processing circuitry is further configured to:
from a plurality of first links of the mobile network that interconnect the identified one or more cell sites and the identified one or more edge cloud data centers, identify one or more first links of the plurality of first links that satisfy the one or more requirements for the network slice subnet;
from a plurality of second links of the mobile network that interconnect the identified one or more edge cloud data centers and the identified one or more regional cloud data centers, identify one or more second links of the plurality of second links that satisfy the one or more requirements for the network slice subnet; and
provision the identified one or more first links and the identified one or more second links to provision the network slice subnet.

4. The computing system of claim 1, wherein to determine the one or more requirements for the network slice subnet, the processing circuitry is configured to:
determine, based on historical telemetry for the mobile network, a predicted resource usage by the network slice subnet of the plurality of RU PNFs, the plurality of cell sites, and the plurality of data centers; and
determine, based at least in part on the predicted resource usage by the network slice subnet, the one or more requirements for the network slice subnet.

5. The computing system of claim 1, wherein the processing circuitry is further configured to:
obtain first information specifying one or more radio performance metrics (PMs) or radio key performance indicators (KPIs) for the plurality of RU PNFs and the plurality of cell sites from at least one of a RAN Intelligent Controller (RIC) or a RAN network function management function (NFMF);
obtain second information specifying compute, storage, and networking resources of the plurality of data centers from an Infrastructure Management Service (IMS); and
obtain third information specifying link telemetry for a plurality of links that interconnect the plurality of data centers from a Transport Network Slice Subnet Management Function (Transport NSSMF), and
wherein the processing circuitry is configured to determine the one or more requirements for the network slice subnet based at least in part on the first information, the second information, and the third information.

6. The computing system of claim 1, wherein the processing circuitry is configured to determine the one or more requirements for the network slice subnet based at least in part on at least one of:
a network slice subnet template for the network slice subnet;
one or more tracking areas to which the network slice subnet is to be deployed; or
one or more Service-level Agreement (SLA) requirements to be satisfied by the plurality of RU PNFs, the plurality of cell sites, and the plurality of data centers as a prerequisite to deployment of the network slice subnet.

7. The computing system of claim 1, wherein the processing circuitry is configured to identify the one or more RU PNFs, the one or more cell sites, and the one or more data centers based at least in part on a determination that each of the one or more RU PNFs, the one or more cell sites, and the one or more data centers satisfies one or more Service-level Agreement (SLA) requirements prerequisite to deployment of the network slice subnet.

8. The computing system of claim 1, wherein the processing circuitry is configured to identify the one or more RU PNFs, the one or more cell sites, and the one or more data centers based at least in part on a determination that a current resource availability of each of the one or more RU PNFs, the one or more cell sites, and the one or more data centers, satisfies a current resource requirement of the network slice subnet.

9. The computing system of claim 1, wherein the processing circuitry is configured to identify the one or more RU PNFs, the one or more cell sites, and the one or more data centers based at least in part on a determination that a current resource availability of each of the one or more PNFs, the one or more cell sites, and the one or more data centers satisfies a predicted resource requirement of the network slice subnet.

10. The computing system of claim 1,
wherein the mobile network comprises a Radio Access Network (RAN),
wherein the processing circuitry is configured to execute a RAN Network Slice Subnet Management Function (RAN NSSMF) for the RAN, and
wherein the network slice subnet comprises a RAN slice subnet.

11. The computing system of claim 1,
wherein the plurality of data centers host a plurality of distributed units (DUs) and a plurality of centralized units (CUs) for the plurality of RU PNFs; and
wherein the processing circuitry is configured to implement an Open Radio Access Network (O-RAN) infrastructure for at least one of a 4th generation (4G), 5th generation (5G), or 6th generation (6G) mobile network.

12. The computing system of claim 1,
wherein each cell site of the plurality of cell sites is associated with a tracking area of a plurality of tracking areas, and
wherein each data center is associated with a geographic location of a plurality of geographic locations.

13. A method comprising:
determining, by processing circuitry of a computing system, one or more requirements for a network slice subnet to be provisioned in a mobile network;
identifying, by the processing circuitry, one or more Radio Unit (RU) physical network functions (PNFs) of a plurality of RU PNFs of the mobile network that satisfy the one or more requirements for the network slice subnet;
from a plurality of cell sites hosting the identified one or more RU PNFs, identifying, by the processing circuitry, one or more cell sites of the plurality of cell sites that satisfy the one or more requirements for the network slice subnet;
identifying, by the processing circuitry and based on the identified one or more cell sites, one or more data centers of a plurality of data centers that satisfy the one or more requirements for the network slice subnet; and
provisioning, by the processing circuitry, the identified one or more RU PNFs, the identified one or more cell sites, and the identified one or more data centers to provision the network slice subnet.

14. The method of claim 1,
wherein the plurality of data centers comprise a plurality of edge cloud data centers, and
wherein the method further comprises:
identifying, by the processing circuitry and based on the identified one or more edge cloud data centers, one or more regional cloud data centers of a plurality of regional cloud data centers of the mobile network that satisfy the one or more requirements for the network slice subnet; and
provisioning, by the processing circuitry, the identified one or more regional cloud data centers to provision the network slice subnet.

15. The method of claim 1, wherein to determining the one or more requirements for the network slice subnet comprises:
determining, based on historical telemetry for the mobile network, a predicted resource usage by the network slice subnet of the plurality of RU PNFs, the plurality of cell sites, and the plurality of data centers; and
determining, based at least in part on the predicted resource usage by the network slice subnet, the one or more requirements for the network slice subnet.

16. The method of claim 1, wherein to determining the one or more requirements for the network slice subnet is based at least in part on at least one of:
a network slice subnet template for the network slice subnet;
one or more tracking areas to which the network slice subnet is to be deployed; or
one or more Service-level Agreement (SLA) requirements to be satisfied by the plurality of RU PNFs, the plurality of cell sites, and the plurality of data centers as a prerequisite to deployment of the network slice subnet.

17. The method of claim 1, wherein identifying the one or more RU PNFs, the one or more cell sites, and the one or more data centers based at least in part on a determination that each of the one or more RU PNFs, the one or more cell sites, and the one or more data centers satisfies one or more Service-level Agreement (SLA) requirements prerequisite to deployment of the network slice subnet.

18. The method of claim 1,
wherein the mobile network comprises a Radio Access Network (RAN),
wherein the processing circuitry is configured to execute a RAN Network Slice Subnet Management Function (RAN NSSMF) for the RAN, and
wherein the network slice subnet comprises a RAN slice subnet.

19. The method of claim 1,
wherein each cell site of the plurality of cell sites is associated with a tracking area of a plurality of tracking areas, and
wherein each data center is associated with a geographic location of a plurality of geographic locations.

20. Non-transitory, computer-readable media comprising instructions that, when executed, are configured to cause processing circuitry to:
determine one or more requirements for a network slice subnet to be provisioned in a mobile network;
identify one or more Radio Unit (RU) physical network functions (PNFs) of a plurality of RU PNFs of the mobile network that satisfy the one or more requirements for the network slice subnet;
from a plurality of cell sites hosting the identified one or more RU PNFs, identify one or more cell sites of the plurality of cell sites that satisfy the one or more requirements for the network slice subnet;
identify, based on the identified one or more cell sites, one or more data centers of a plurality of data centers that satisfy the one or more requirements for the network slice subnet; and
provision the identified one or more RU PNFs, the identified one or more cell sites, and the identified one or more data centers to provision the network slice subnet.
